(19) United States
(12) Patent Application Publication
(10) Pub. No.: US 2026/0302918 A1
(43) Pub. Date: Oct. 1, 2026

(54) SWITCHING POWER SUPPLY APPARATUS

(71) Applicant: Astemo, Ltd., Tokyo (JP)

(72) Inventor: Hisanori CHO, Tokyo (JP)

(73) Assignee: Astemo, Ltd., Tokyo (JP)

(21) Appl. No.: 19/462,174

(22) Filed: Jan. 28, 2026

(30) Foreign Application Priority Data
Mar. 25, 2025 (JP) 2025-049539

(51) Int. Cl. H02M 1/00; H02M 1/32; H02M 3/00; H02M 3/335

(52) U.S. Cl. CPC H02M 1/0038; H02M 1/32; H02M 3/01; H02M 3/33592

(57) ABSTRACT

An electric power conversion apparatus includes: a pair of input terminals including first and second input terminals; a pair of output terminals; a transformer; a switching circuit; a rectifying circuit; a smoothing circuit; and a control circuit that performs switching driving. In the switching circuit, four switching devices are disposed in series on a first coupling line, and two input capacitors are disposed in series on a second coupling line; a first diode is disposed between a first node and a second node, and a second diode is disposed between a third node and the first node; a resonant coil and a primary winding are disposed in series between a fourth node and the first node; and a first clamp diode is disposed between a fifth node and the first input terminal, and a second clamp diode is disposed between the second input terminal and the fifth node.

### CROSS-REFERENCE TO RELATED APPLICATIONS

The present application claims priority from Japanese Patent Application No. 2025-049539 filed on Mar. 25, 2025, the entire contents of which are hereby incorporated by reference.

### BACKGROUND

The disclosure relates to a switching power supply apparatus that converts electric power through the use of a switching device.

Various types of switching power supply apparatuses or electric power conversion apparatuses, including DC-to-DC converters, have been proposed. For example, reference is made to Japanese Patent No. 6008185.

### SUMMARY

A switching power supply apparatus according to one embodiment of the disclosure includes a pair of input terminals, a pair of output terminals, a transformer, a switching circuit, a rectifying circuit, a smoothing circuit, and a control circuit. The pair of input terminals are configured to receive an input voltage, and include a first input terminal and a second input terminal. The pair of output terminals are configured to output an output voltage. The transformer includes a primary winding and a secondary winding. The switching circuit is disposed between the pair of input terminals and the primary winding, and includes a first coupling line, a second coupling line, first to fourth switching devices, a first input capacitor, a second input capacitor, a first diode, a second diode, a first clamp diode, a second clamp diode, and a resonant coil. The first coupling line and the second coupling line are disposed in parallel to each other between the first input terminal and the second input terminal. The rectifying circuit is disposed between the pair of output terminals and the secondary winding, and includes a plurality of rectifiers. The smoothing circuit is disposed between the pair of output terminals and the rectifying circuit. The control circuit is configured to perform switching driving to control respective operations of the first to fourth switching devices. In the switching circuit, the first input capacitor and the second input capacitor are disposed on the first coupling line in series to each other and in this order in a direction from the first input terminal toward the second input terminal; the first to fourth switching devices are disposed on the second coupling line in series to each other and in this order in the direction from the first input terminal toward the second input terminal; the first diode is disposed between a first node and a second node, and the second diode is disposed between a third node and the first node, the first node being a node between the first input capacitor and the second input capacitor, the second node being a node between the first switching device and the second switching device, the third node being a node between the third switching device and the fourth switching device; the resonant coil and the primary winding are disposed in series to each other between a fourth node and the first node, the fourth node being a node between the second switching device and the third switching device; and the first clamp diode is disposed between a fifth node and the first input terminal, and the second clamp diode is disposed between the second input terminal and the fifth node, the fifth node being a node between the resonant coil and the primary winding.

### BRIEF DESCRIPTION OF THE DRAWINGS

The accompanying drawings are included to provide a further understanding of the disclosure, and are incorporated in and constitute a part of this specification. The drawings illustrate embodiments and, together with the specification, serve to explain the principles of the disclosure.

FIG. 1 is a circuit diagram illustrating a schematic configuration example of a switching power supply apparatus according to one example embodiment of the disclosure.

FIG. 2 is a timing chart illustrating an example of a first driving operation during switching driving according to the example embodiment.

FIG. 3 is a circuit diagram illustrating an operation state during "Stage 1A" in FIG. 2.

FIG. 4 is a circuit diagram illustrating an operation state during "Stage 2A" in FIG. 2.

FIG. 5 is a circuit diagram illustrating an operation state during "Stage 3A" in FIG. 2.

FIG. 6 is a circuit diagram illustrating an operation state during "Stage 4A" in FIG. 2.

FIG. 7 is a circuit diagram illustrating an operation state during "Stage 1B" in FIG. 2.

FIG. 8 is a circuit diagram illustrating an operation state during "Stage 2B" in FIG. 2.

FIG. 9 is a circuit diagram illustrating an operation state during "Stage 3B" in FIG. 2.

FIG. 10 is a circuit diagram illustrating an operation state during "Stage 4B" in FIG. 2.

FIG. 11 is a timing chart illustrating an example of a second driving operation during the switching driving according to the example embodiment.

FIG. 12 is a circuit diagram illustrating an operation state during "Stage 4A" in FIG. 11.

FIG. 13 is a circuit diagram illustrating an operation state during "Stage 4B" in FIG. 11.

FIG. 14 is a timing chart illustrating an example of a third driving operation during the switching driving according to the example embodiment.

FIG. 15 is a circuit diagram illustrating an operation state during "Stage 4A" in FIG. 14.

FIG. 16 is a circuit diagram illustrating an operation state during "Stage 4B" in FIG. 14.

FIG. 17 is a timing chart illustrating an example of a fourth driving operation during the switching driving according to the example embodiment.

FIG. 18 is a circuit diagram illustrating an operation state during "Stage 4A" in FIG. 17.

FIG. 19 is a circuit diagram illustrating an operation state during "Stage 4B" in FIG. 17.

FIG. 20 is a circuit diagram illustrating a schematic configuration example of a switching power supply apparatus according to Modification Example 1.

FIG. 21 is a circuit diagram illustrating a schematic configuration example of a switching power supply apparatus according to Modification Example 2.

FIG. 22 is a circuit diagram illustrating an example of an equivalent circuit of Modification Examples 1 and 2.

FIG. 23 is a circuit diagram illustrating a configuration example of a transformer and a rectifying circuit according to Modification Example 3.

### DETAILED DESCRIPTION

What is desired of a switching power supply apparatus is to suppress a surge voltage occurring on a secondary side of a transformer, while suppressing an effect on an operation of a main circuit.

It is desirable to provide a switching power supply apparatus that makes it possible to suppress a surge voltage occurring on the secondary side of a transformer, while suppressing an effect on the operation of a main circuit.

In the following, some example embodiments of the disclosure are described in detail with reference to the accompanying drawings. Note that the following description is directed to illustrative examples of the disclosure and not to be construed as limiting to the disclosure. Factors including, without limitation, numerical values, shapes, materials, components, positions of the components, and how the components are coupled to each other are illustrative only and not to be construed as limiting to the disclosure. Further, elements in the following example embodiments which are not recited in a most-generic independent claim of the disclosure are optional and may be provided on an as-needed basis. The drawings are schematic and are not intended to be drawn to scale. Throughout the present specification and the drawings, elements having substantially the same function and configuration are denoted with the same reference numerals to avoid any redundant description. In addition, elements that are not directly related to any embodiment of the disclosure are unillustrated in the drawings. Note that the description is given in the following order.

### 1. Example Embodiment: Basic configuration example

### 2. Modification Examples

Modification Examples 1 and 2: Other configuration examples of a switching circuit

Modification Example 3: Another configuration example of a rectifying circuit

### 3. Other Modification Examples

### 1. Example Embodiment

### Configuration

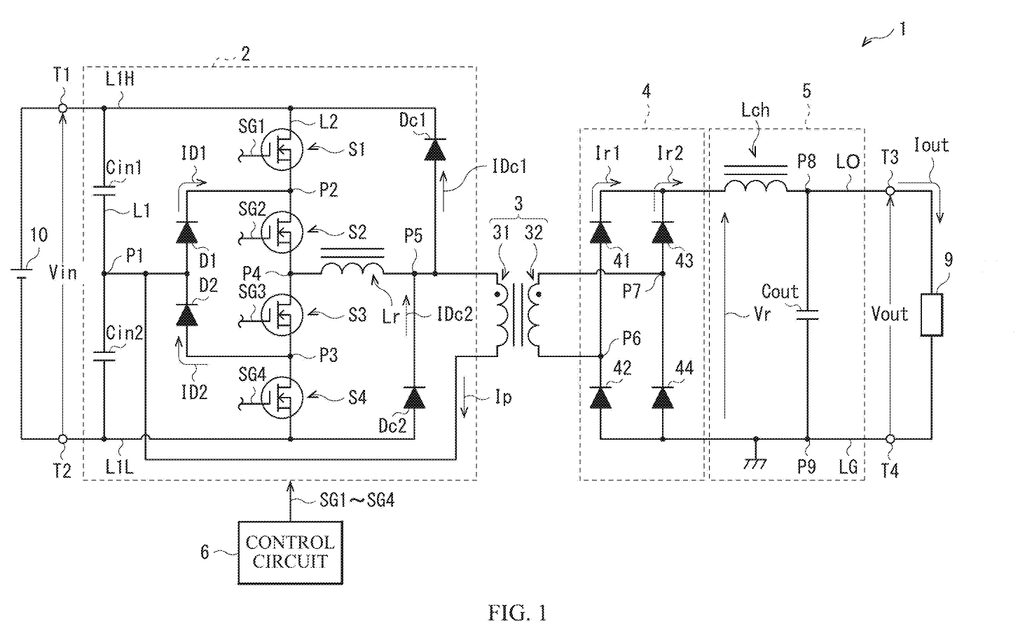

FIG. 1 is a circuit diagram illustrating a schematic configuration example of a switching power supply apparatus 1 according to an example embodiment of the disclosure.

The switching power supply apparatus 1 may serve as a DC-to-DC converter that performs a voltage conversion on a direct-current input voltage Vin supplied from a direct-current input power supply 10, such as a battery, into a direct-current output voltage Vout and supplies electric power to a load 9.

Non-limiting examples of the load 9 may include electronic equipment and a battery. The switching power supply apparatus 1 may perform either an up conversion, i.e., a step-up conversion, or a down conversion, i.e., a step-down conversion, as a way of the voltage conversion.

The direct-current input voltage Vin may correspond to a specific but non-limiting example of an "input voltage" in one embodiment of the disclosure. The direct-current output voltage Vout may correspond to a specific but non-limiting example of an "output voltage" in one embodiment of the disclosure.

The switching power supply apparatus 1 includes two input terminals T1 and T2, two output terminals T3 and T4, a switching circuit 2, a transformer 3, a rectifying circuit 4, a smoothing circuit 5, and a control circuit 6. The direct-current input voltage Vin may be inputted to between the input terminals T1 and T2. The direct-current output voltage Vout may be outputted from between the output terminals T3 and T4.

The input terminals T1 and T2 may correspond to a specific but non-limiting example of a "pair of input terminals" in one embodiment of the disclosure. The output terminals T3 and T4 may correspond to a specific but non-limiting example of a "pair of output terminals" in one embodiment of the disclosure. The input terminal T1 may correspond to a specific but non-limiting example of a "first input terminal" in one embodiment of the disclosure. The input terminal T2 may correspond to a specific but non-limiting example of a "second input terminal" in one embodiment of the disclosure.

### A. Switching Circuit 2

As illustrated in FIG. 1, the switching circuit 2 is disposed between the input terminals T1 and T2 and a primary winding 31 of the transformer 3. The primary winding 31 will be described later. The switching circuit 2 includes two coupling lines L1 and L2, four switching devices S1 to S4, two input smoothing capacitors Cin1 and Cin2, two diodes D1 and D2, two clamp diodes Dc1 and Dc2, and a resonant coil Lr.

The two coupling lines L1 and L2 are disposed in parallel to each other between the input terminal T1 and the input terminal T2, that is, between a primary high voltage line L1H coupled to the input terminal T1 and a primary low voltage line L1L coupled to the input terminal T2.

As illustrated in FIG. 1, the two input smoothing capacitors Cin1 and Cin2 are disposed on the coupling line L1 in series to each other and in this order in a direction from the input terminal T1 or the primary high voltage line L1H toward the input terminal T2 or the primary low voltage line L1L. These input smoothing capacitors Cin1 and Cin2 may each be adapted to smooth the direct-current input voltage Vin.

Further, as illustrated in FIG. 1, the four switching devices S1 to S4 are disposed on the coupling line L2 in series to each other and in this order in the direction from the input terminal T1 toward the input terminal T2.

As the switching devices S1 to S4, for example, any of various type of switching devices including, without limitation, field-effect transistors including metal-oxide-semiconductor field-effect transistors (MOS-FETs), insulated gate bipolar transistors (IGBTs), and high electron mobility transistors (HEMTs), i.e., heterostructure field-effect transistors (HFETs), may be used. Non-limiting examples of the HEMTs may include a gallium nitride (GaN) transistor.

In the example embodiment illustrated in FIG. 1, the switching devices S1 to S4 may each include a transistor configured by a MOS-FET or a HEMT. When the MOS-FETs or the HEMTs are used as the switching devices S1 to S4, respective diodes to be coupled in parallel to the switching devices S1 to S4 may be configured by respective parasitic diodes of the MOS-FETs or the HEMTs.

Respective switching operations, i.e., ON and OFF operations, of the switching devices S1 to S4 may be controlled in accordance with driving signals SG1 to SG4 supplied from the control circuit 6 to be described later. As a result, the direct-current input voltage Vin applied to between the input terminals T1 and T2 may be converted into an alternating-current voltage, and the alternating-current voltage may be outputted to the primary winding 31 of the transformer 3, as will be described in detail later.

The diode D1 is disposed between a node P1 and a node P2. The node P1 is a node between the input smoothing capacitors Cin1 and Cin2. The node P2 is a node between the switching devices S1 and S2. For example, the diode D1 may have an anode coupled to the node P1 and a cathode coupled to the node P2. The diode D2 is disposed between a node P3 and the node P1. The node P3 is a node between the switching devices S3 and S4. For example, the diode D2 may have an anode coupled to the node P3 and a cathode coupled to the node P1.

Further, as illustrated in FIG. 1, the resonant coil Lr and the primary winding 31 of the transformer 3 to be described later are disposed in series to each other between a node P4 and the node P1. The node P4 is a node between the switching device S2 and S3. For example, the resonant coil Lr may have a first end coupled to the node P4 and a second end couple to a first end of the primary winding 31. A second end of the primary winding 31 may be coupled to the node P1.

As illustrated in FIG. 1, the clamp diode Dc1 is disposed between a node P5 and the input terminal T1 (the primary high voltage line L1H). The node P5 is a node between the resonant coil Lr and the primary winding 31. For example, the clamp diode Dc1 may have an anode coupled to the node P5 and a cathode coupled to the input terminal T1. The clamp diode Dc2 is disposed between the input terminal T2 (the primary low voltage line L1L) and the node P5. For example, the clamp diode Dc2 may have an anode coupled to the input terminal T2 and a cathode coupled to the node P5.

The coupling line L1 may correspond to a specific but non-limiting example of a "first coupling line" in one embodiment of the disclosure, and the coupling line L2 may correspond to a specific but non-limiting example of a "second coupling line" in one embodiment of the disclosure. The input smoothing capacitor Cin1 may correspond to a specific but non-limiting example of a "first input capacitor" in one embodiment of the disclosure, and the input smoothing capacitor Cin2 may correspond to a specific but non-limiting example of a "second input capacitor" in one embodiment of the disclosure. The switching device S1 may correspond to a specific but non-limiting example of a "first switching device" in one embodiment of the disclosure, and the switching device S2 may correspond to a specific but non-limiting example of a "second switching device" in one embodiment of the disclosure. The switching device S3 may correspond to a specific but non-limiting example of a "third switching device" in one embodiment of the disclosure, and the switching device S4 may correspond to a specific but non-limiting example of a "fourth switching device" in one embodiment of the disclosure. The diode D1 may correspond to a specific but non-limiting example of a "first diode" in one embodiment of the disclosure, and the diode D2 may correspond to a specific but non-limiting example of a "second diode" in one embodiment of the disclosure. The clamp diode Dc1 may correspond to a specific but non-limiting example of a "first clamp diode" in one embodiment of the disclosure, and the clamp diode Dc2 may correspond to a specific but non-limiting example of a "second clamp diode" in one embodiment of the disclosure. The node P1 may correspond to a specific but non-limiting example of a "first node" in one embodiment of the disclosure, the node P2 may correspond to a specific but non-limiting example of a "second node" in one embodiment of the disclosure, and the node P3 may correspond to a specific but non-limiting example of a "third node" in one embodiment of the disclosure. The node P4 may correspond to a specific but non-limiting example of a "fourth node" in one embodiment of the disclosure, and the node P5 may correspond to a specific but non-limiting example of a "fifth node" in one embodiment of the disclosure.

### B. Transformer 3

The transformer 3 may include one primary winding 31 and one secondary winding 32.

The primary winding 31 may have the first end coupled to the node P5 in the switching circuit 2, and the second end coupled to the node P1 in the switching circuit 2. The secondary winding 32 may have a first end coupled to a node P7 in the rectifying circuit 4 to be described later, and a second end coupled to a node P6 in the rectifying circuit 4.

A voltage in the form of a rectangular pulse wave generated by the switching circuit 2 may be supplied to the primary winding 31 of the transformer 3. The voltage in the form of the rectangular pulse wave supplied to the primary winding 31 may be transformed by the transformer 3, and an alternating-current voltage resulting from the transformation may be outputted from between the first end and the second end of the secondary winding 32. Note that a degree of voltage conversion of the direct-current output voltage Vout with respect to the direct-current input voltage Vin in this case may be determined based on a turns ratio between the primary winding 31 and the secondary winding 32, a switching period Tsw to be described later, and an on-duty ratio of the switching circuit 2.

### C. Rectifying Circuit 4 and Smoothing Circuit 5

The rectifying circuit 4 is disposed between the output terminals T3 and T4 and the secondary winding 32 of the transformer 3. For example, the rectifying circuit 4 may be disposed between the smoothing circuit 5 to be described later and the secondary winding 32. The rectifying circuit 4 may include a plurality of (i.e., four) rectifying diodes 41 to 44, and may thus include what is called a "full-bridge" rectifying circuit.

In the rectifying circuit 4, a series coupling structure in which the rectifying diodes 41 and 42 are coupled in series to each other and a series coupling structure in which the rectifying diodes 43 and 44 are coupled in series to each other may be disposed in parallel to each other between the output terminals T3 and T4, that is, between an output line LO and a ground line LG. For example, the rectifying diode 41 may have an anode coupled to the node P6 and a cathode coupled to the output line LO, and the rectifying diode 42 may have an anode coupled to the ground line LG and a cathode coupled to the node P6. The rectifying diode 43 may have an anode coupled to the node P7 and a cathode coupled to the output line LO, and the rectifying diode 44 may have an anode coupled to the ground line LG and a cathode coupled to the node P7. The secondary winding 32 described above may be disposed between the node P6 and the node P7.

The rectifying diodes 41 to 44 may correspond to a specific but non-limiting example of a "plurality of rectifiers" in one embodiment of the disclosure.

The smoothing circuit 5 may be disposed between the output terminals T3 and T4 and the secondary winding 32. For example, the smoothing circuit 5 is disposed between the output terminals T3 and T4 and the rectifying circuit 4. The smoothing circuit 5 may include one output smoothing capacitor Cout and one choke coil Lch. For example, the output smoothing capacitor Cout may be disposed between a node P8 on the output line LO and a node P9 on the ground line LG, that is, between the output terminals T3 and T4. The choke coil Lch may be interposed onto the output line LO and positioned between the cathode of each of the rectifying diodes 41 and 43 and the node P8.

In the rectifying circuit 4 and the smoothing circuit 5 having such respective configurations, the alternating-current voltage outputted from the transformer 3 may be rectified by the four rectifying diodes 41 to 44, and the voltage rectified at the rectifying circuit 4 may be smoothed by the output smoothing capacitor Cout and the choke coil Lch into the direct-current output voltage Vout. The direct-current output voltage Vout generated in this way may cause a direct-current output current Iout or a load current to flow to the load 9 described above, and cause electric power to be supplied from the output terminals T3 and T4 to the load 9.

In some embodiments, the rectifying diodes 41 to 44 may include switching devices similar to the switching devices S1 to S4 described above, and such switching devices may be caused to perform synchronous rectification, that is, caused to be in an ON state in synchronization with time periods during which respective parasitic diodes of those switching devices are conducting. For example, switching operations (i.e., ON and OFF operations) of the switching devices may be controlled in accordance with respective driving signals supplied from the control circuit 6 to be described later to thereby cause the switching devices to perform such synchronous rectification.

### D. Control Circuit 6

The control circuit 6 may control the respective switching operations of the switching devices S1 to S4 of the switching circuit 2. In other words, the control circuit 6 may perform switching driving to control the respective switching operations of the switching devices S1 to S4.

For example, the control circuit 6 may supply the respective driving signals SG1 to SG4 to the switching devices S1 to S4 individually to thereby control the respective switching operations, i.e., ON and OFF operations, of the switching devices S1 to S4 individually.

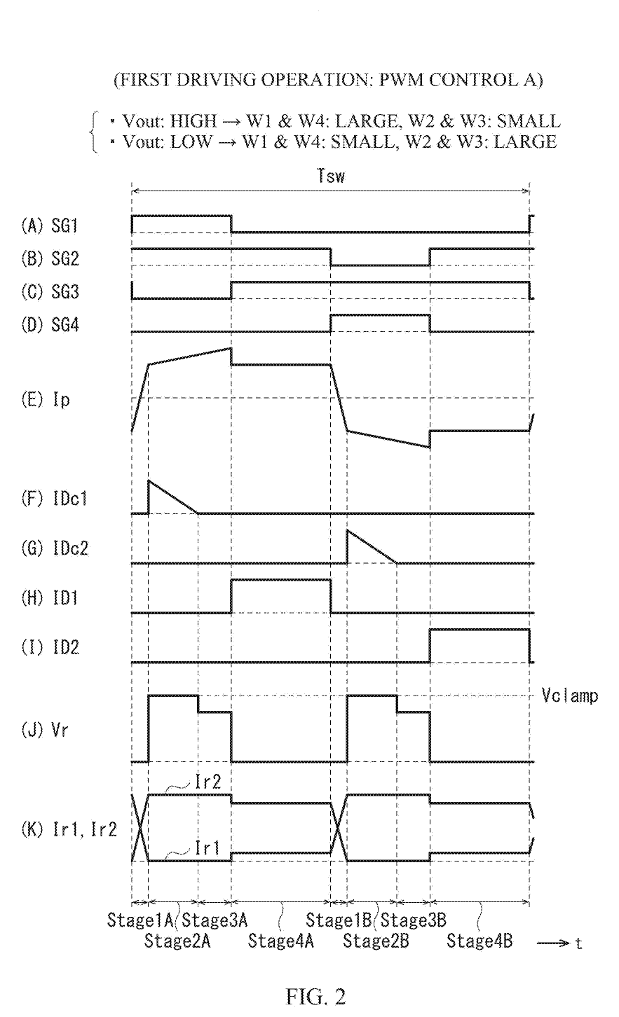

Details of the above-described switching driving to be performed by the control circuit 6 will be described later with reference to FIGS. 2 to 19.

### Operation, Workings, and Example Effects

### A. Basic Operation

In the switching power supply apparatus 1, the direct-current input voltage Vin may be supplied from the direct-current input power supply 10 to the switching circuit 2 via the input terminals T1 and T2. In the switching circuit 2, the switching devices S1 to S4 may perform the switching operations to thereby generate a voltage in the form of a rectangular pulse wave. The voltage in the form of the rectangular pulse wave may be supplied to the primary winding 31 of the transformer 3. The voltage in the form of the rectangular pulse wave supplied to the primary winding 31 may be transformed by the transformer 3, and an alternating-current voltage resulting from the transformation may thus be outputted from the secondary winding 32.

In the rectifying circuit 4, the alternating-current voltage outputted from the transformer 3, i.e., the alternating-current voltage resulting from the transformation described above, may be rectified by the rectifying diodes 41 to 44, and may thereafter be smoothed by the smoothing circuit 5. The direct-current output voltage Vout may thus be outputted from the output terminals T3 and T4. The direct-current output voltage Vout may cause the output current Iout to flow to the load 9 and cause electric power to be supplied to the load 9.

### B. Example Operation during Switching Driving

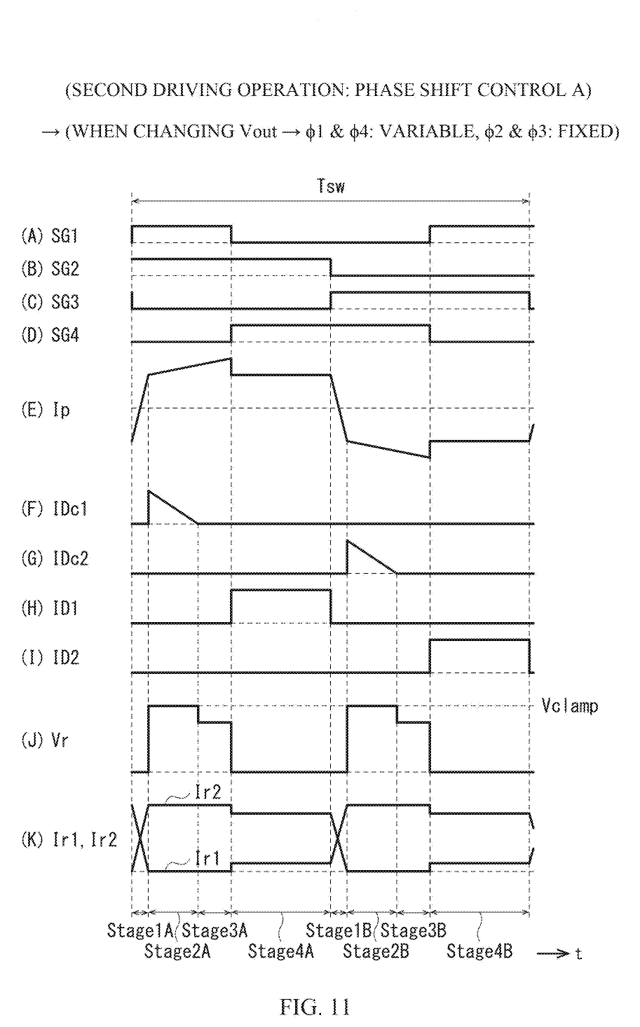

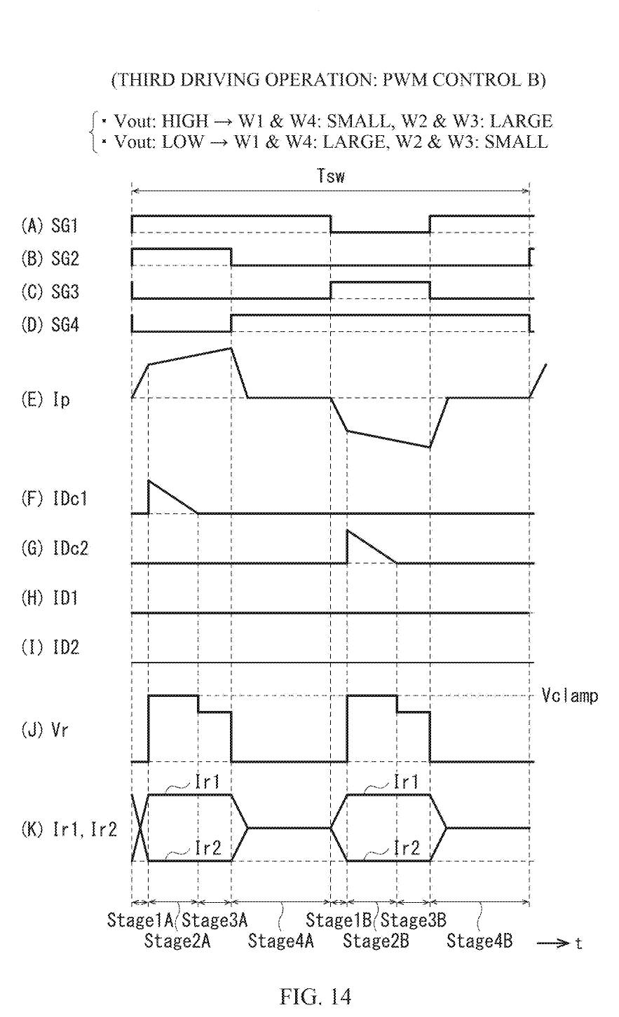

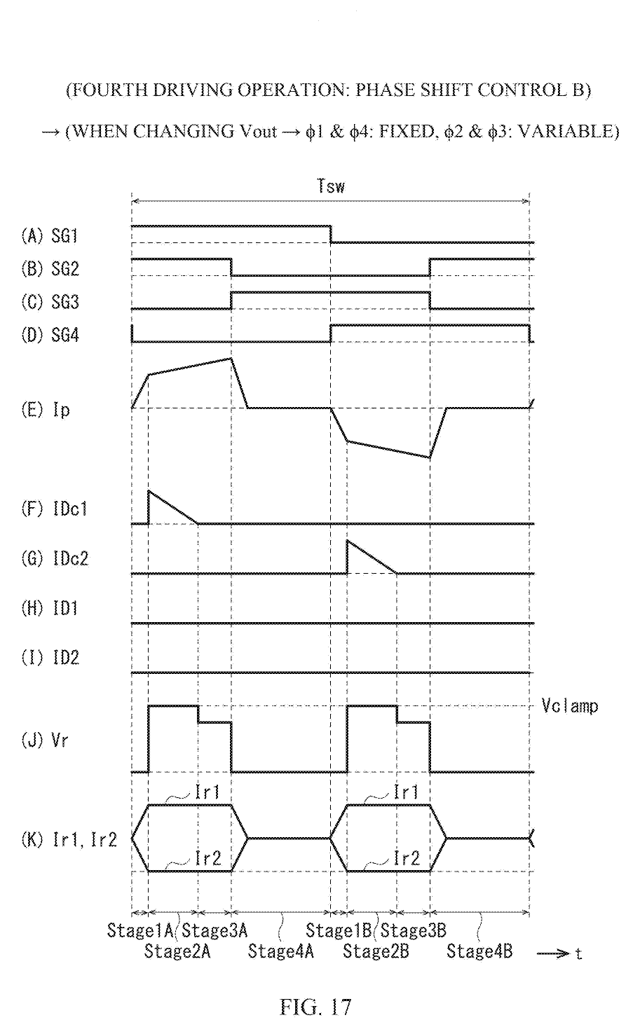

A detailed operation of the switching power supply apparatus 1, that is, an example operation of the switching power supply apparatus 1 during the switching driving described above, will now be described with reference to FIGS. 2 to 19, as well as FIG. 1. For example, FIGS. 2 to 10 illustrate an example of a first driving operation, that is, a driving operation in accordance with "pulse width modulation (PWM) control A" to be described later, and FIGS. 11 to 13 illustrate an example of a second driving operation, that is, a driving operation in accordance with "phase shift control A" to be described later. FIGS. 14 to 16 illustrate an example of a third driving operation, that is, a driving operation in accordance with "PWM control B" to be described later, and FIGS. 17 to 19 illustrate an example of a fourth driving operation, that is, a driving operation in accordance with "phase shift control B" to be described later.

### B-1. Example of First Driving Operation: PWM Control A

FIG. 2 is a timing chart illustrating an operation example of the first driving operation, i.e., the "PWM control A" described above, during the switching driving in the switching power supply apparatus 1. In FIG. 2, parts (A) to (D) illustrate respective waveforms of the driving signals SG1 to SG4 described above, and part (E) illustrates a waveform of a current Ip (see FIG. 1) flowing through the primary winding 31. Parts (F) and (G) illustrate respective waveforms of currents IDc1 and IDc2 (see FIG. 1) flowing through the clamp diodes Dc1 and Dc2, respectively, and parts (H) and (I) illustrate respective waveforms of currents ID1 and ID2 (see FIG. 1) flowing through the diodes D1 and D2, respectively. Further, part (J) illustrates a waveform of a voltage Vr (see FIG. 1) outputted from the rectifying circuit 4, and part (K) illustrates a waveform of a current Ir1 (see FIG. 1) flowing from the rectifying diode 41 and a waveform of a current Ir2 (see FIG. 1) flowing from the rectifying diode 43. In FIG. 2, a horizontal axis represents time t, and the same applies to subsequent timing charts.

A time period during which each of the driving signals SG1 to SG4 is in a "high (H)" state may correspond to a time period during which corresponding one of the switching devices S1 to S4 is in an ON state. A time period during which each of the driving signals SG1 to SG4 is in a "low (L)" state may correspond to a time period during which corresponding one of the switching devices S1 to S4 is in an OFF state.

Referring to FIG. 2, respective time periods for eight kinds of operation states, that is, respective time periods for "Stage 1A", "Stage 2A", "Stage 3A", "Stage 4A", "Stage 1B", "Stage 2B", "Stage 3B", and "Stage 4B", may be set along time t. These time periods for the eight kinds of operation states may proceed in sequence (i.e., in the order of "Stage 1A" to "Stage 4B" described above) repeatedly to define the switching period Tsw (= 1/switching frequency fsw), as illustrated in FIG. 2. In other words, the control circuit 6 may perform the above-described switching driving with the predetermined switching period Tsw including the respective time periods for the above-described eight kinds of operation states.

As illustrated in FIG. 2, during the time periods for "Stage 1A", "Stage 2A", and "Stage 3A", the switching devices S1 and S2 may each be set in the ON state and the switching devices S3 and S4 may each be set in the OFF state. During the time period for "Stage 4A", the switching devices S2 and S3 may each be set in the ON state and the switching devices S1 and S4 may each be set in the OFF state. During the time periods for "Stage 1B", "Stage 2B", and "Stage 3B", the switching devices S3 and S4 may each be set in the ON state and the switching devices S1 and S2 may each be set in the OFF state. During the time period for "Stage 4B", the switching devices S2 and S3 may each be set in the ON state and the switching devices S1 and S4 may each be set in the OFF state.

In performing the first driving operation, i.e., the "PWM control A" described above, the control circuit 6 may perform the following switching driving, as illustrated in FIG. 2. When setting the direct-current output voltage Vout to be relatively high, the control circuit 6 may set respective pulse widths W1 and W4 of the driving signals SG1 and SG4 for the switching devices S1 and S4 to be relatively large. In this case, the control circuit 6 may set respective pulse widths W2 and W3 of the driving signals SG2 and SG3 for the switching devices S2 and S3 to be relatively small. In contrast, when setting the direct-current output voltage Vout to be relatively low, the control circuit 6 may set the respective pulse widths W1 and W4 of the driving signals SG1 and SG4 to be relatively small, and set the respective pulse widths W2 and W3 of the driving signals SG2 and SG3 to be relatively large.

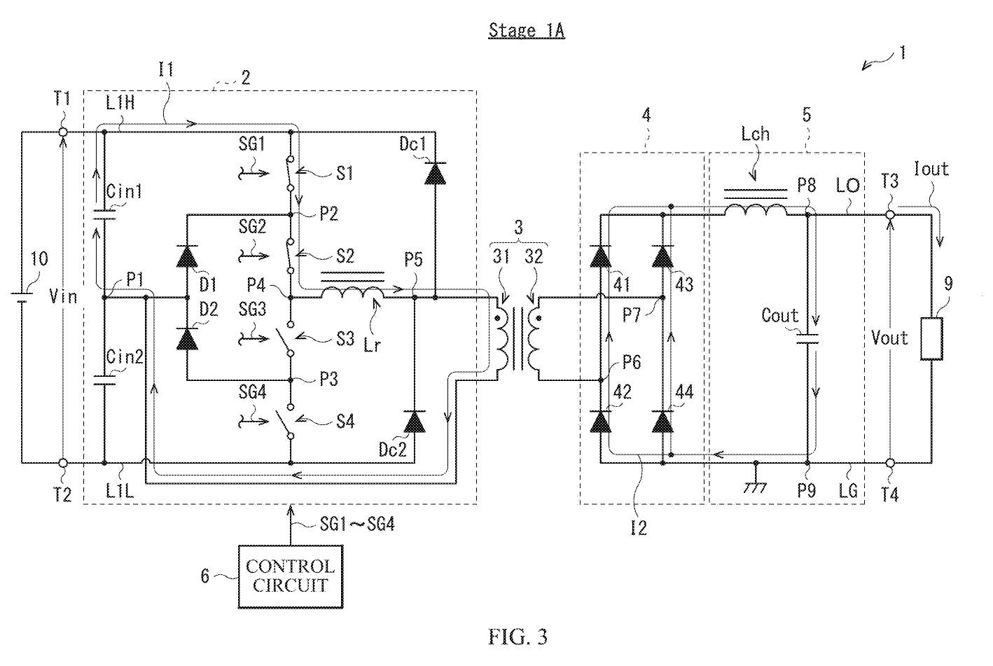

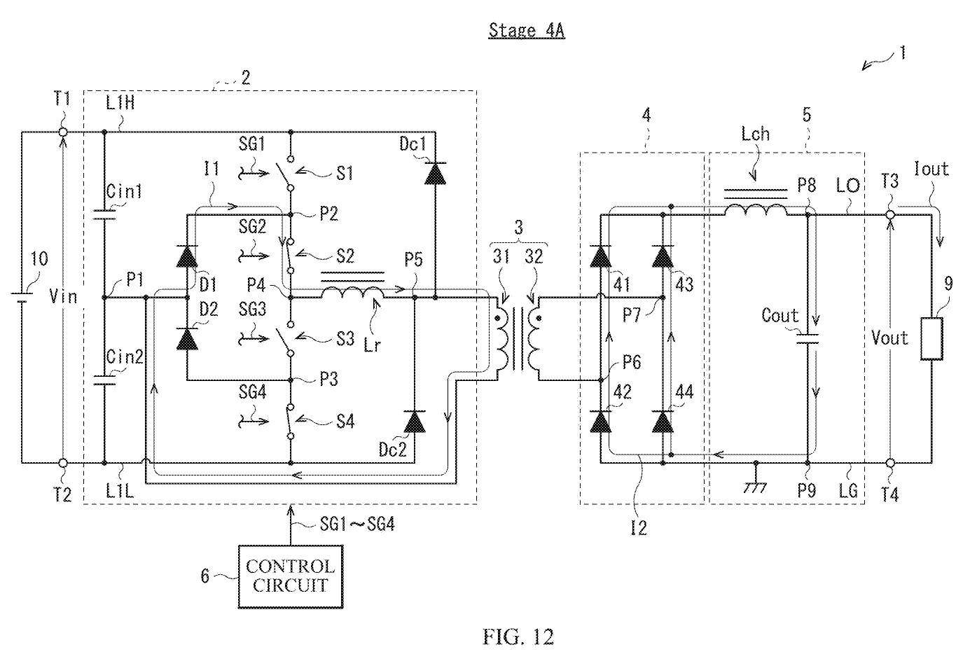

FIGS. 3 to 10 are circuit diagrams illustrating the operation states of the switching power supply apparatus 1 during the respective time periods for "Stage 1A", "Stage 2A", "Stage 3A", "Stage 4A", "Stage 1B", "Stage 2B", "Stage 3B", and "Stage 4B" in FIG. 2. An example operation in each of these operation states will be described in detail below with reference to FIG. 2. For convenience, in FIGS. 3 to 10, and also in FIGS. 12, 13, 15, 16, 18 and 19 to be described later, the switching devices S1 to S4 are each schematically illustrated in a switch shape.

### Time Period for "Stage 1A"

First, during the time period for "Stage 1A" illustrated in FIG. 3, the switching devices S1 and S2 may each be set in the ON state and the switching devices S3 and S4 may each be set in the OFF state (see parts (A) to (D) of FIG. 2), as described above. In this case, on a primary side of the transformer 3, a primary circuit current (i.e., a current I1) may flow over a path from the input smoothing capacitor Cin1, through the primary high voltage line L1H, the switching device S1, the switching device S2, the resonant coil Lr, and the primary winding 31 in this order, and back to the input smoothing capacitor Cin1. On a secondary side of the transformer 3, a secondary circuit current (i.e., a current I2) may flow over a path from the output smoothing capacitor Cout, through the ground line LG, thereafter through the rectifying diodes 42 and 41 and the rectifying diodes 44 and 43 in parallel, thereafter through the choke coil Lch, and back to the output smoothing capacitor Cout.

### Time Period for "Stage 2A"

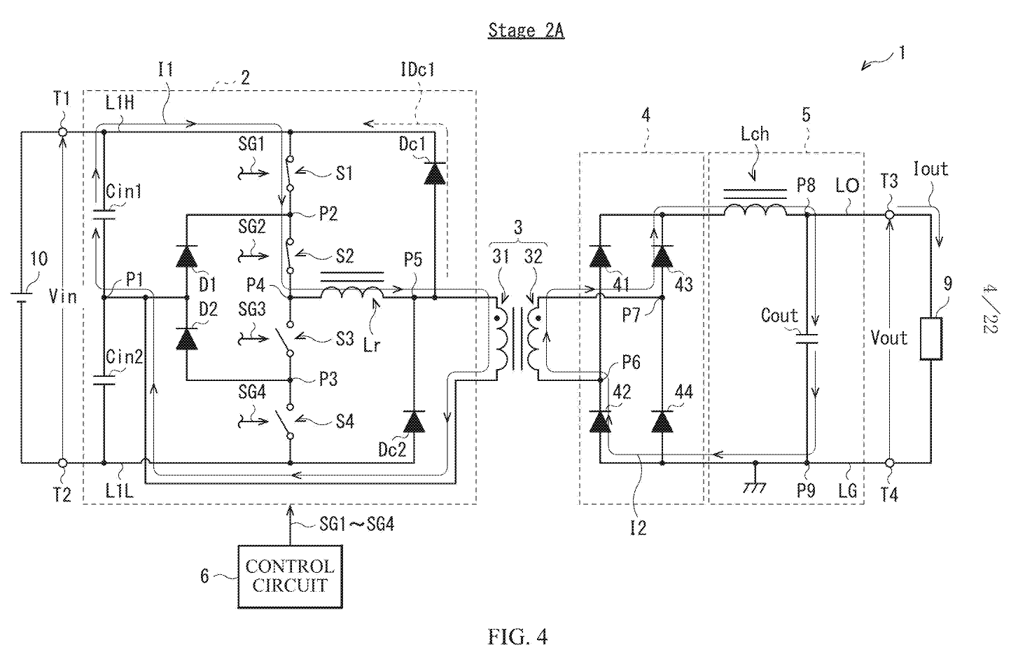

Thereafter, during the time period for "Stage 2A" illustrated in FIG. 4 also, the switching devices S1 and S2 may each be set in the ON state and the switching devices S3 and S4 may each be set in the OFF state (see parts (A) to (D) of FIG. 2), as described above. In this case, on the primary side of the transformer 3, the primary circuit current (i.e., the current I1) may flow over the same path as that during the time period for "Stage 1A" described above, and the current IDc1 may flow through the clamp diode Dc1, as indicated in a dashed arrow in FIG. 4. On the secondary side of the transformer 3, the secondary circuit current (i.e., the current I2) may flow over a path from the secondary winding 32, through the rectifying diode 43, the choke coil Lch, the output smoothing capacitor Cout, the ground line LG, and the rectifying diode 42 in this order, and back to the secondary winding 32.

### Time Period for "Stage 3A"

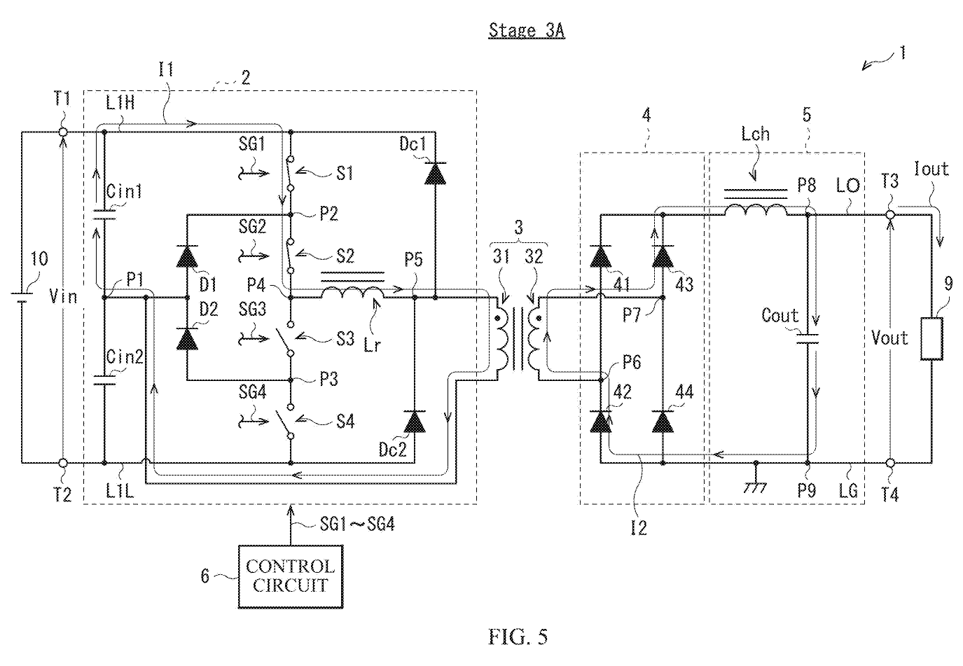

Thereafter, during the time period for "Stage 3A" illustrated in FIG. 5 also, the switching devices S1 and S2 may each be set in the ON state and the switching devices S3 and S4 may each be set in the OFF state (see parts (A) to (D) of FIG. 2), as described above. In this case, on the primary side of the transformer 3, the primary circuit current (i.e., the current I1) may flow over the same path as that during the time period for "Stage 1A" described above, but no current IDc1 may flow through the clamp diode Dc1, unlike during the time period for the "Stage 2A" described above. On the secondary side of the transformer 3, the secondary circuit current (i.e., the current I2) may flow over the same path as that during the time period for "Stage 2A" described above.

### Time Period for "Stage 4A"

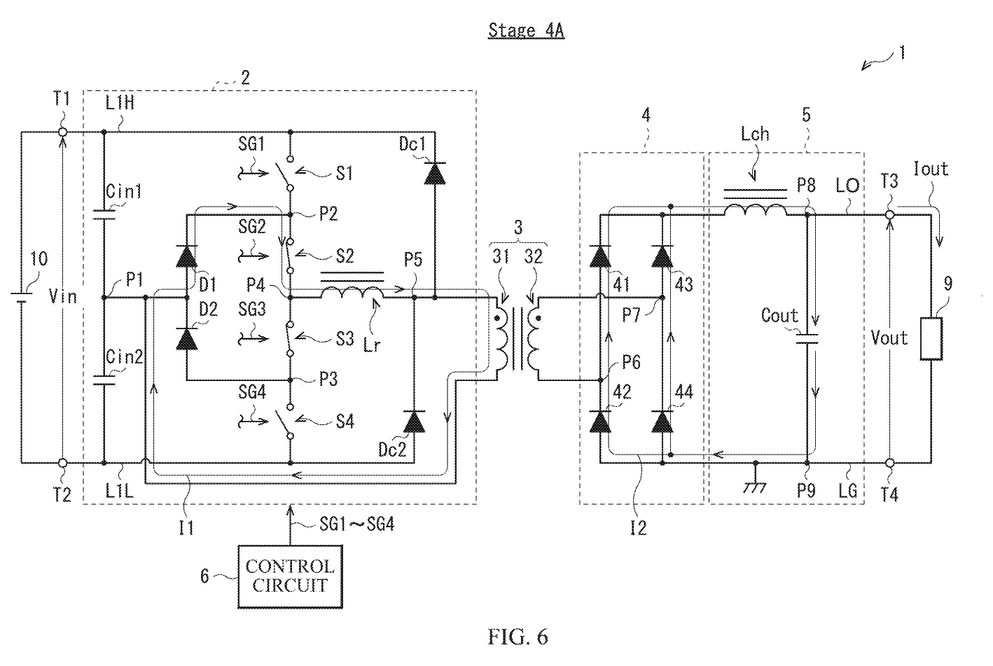

Thereafter, during the time period for "Stage 4A" illustrated in FIG. 6, the switching devices S2 and S3 may each be set in the ON state and the switching devices S1 and S4 may each be set in the OFF state (see parts (A) to (D) of FIG. 2), as described above. In this case, on the primary side of the transformer 3, the primary circuit current (i.e., the current I1) may flow over a path from the resonant coil Lr, through the primary winding 31, the diode D1, and the switching device S2 in this order, and back to the resonant coil Lr. On the secondary side of the transformer 3, the secondary circuit current (i.e., the current I2) may flow over the same path as that during the time period for "Stage 1A" described above.

### Time Period for "Stage 1B"

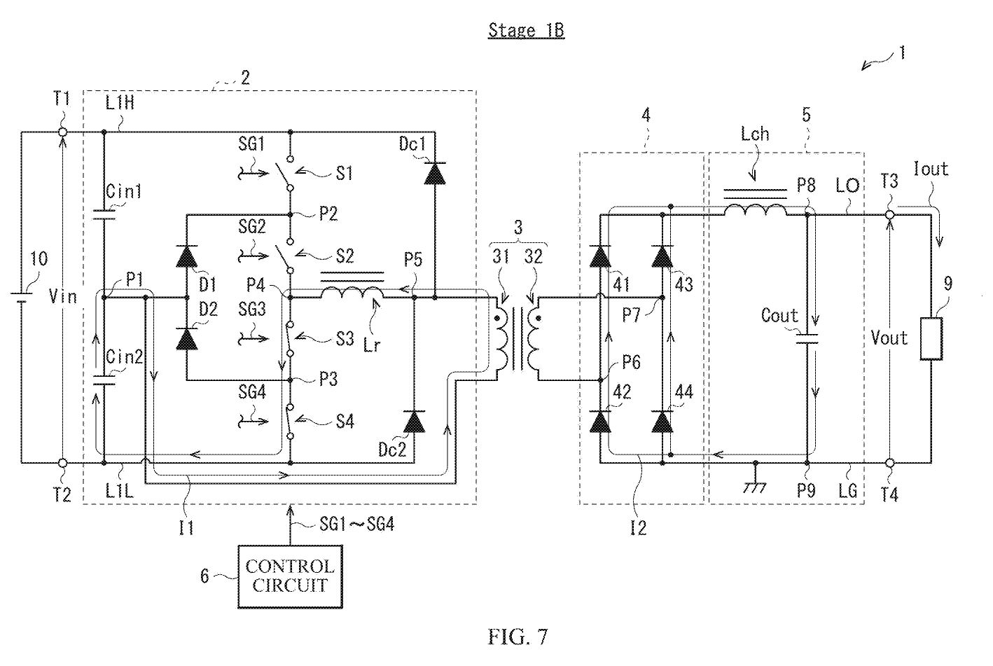

Thereafter, during the time period for "Stage 1B" illustrated in FIG. 7, the switching devices S3 and S4 may each be set in the ON state and the switching devices S1 and S2 may each be set in the OFF state (see parts (A) to (D) of FIG. 2), as described above. In this case, on the primary side of the transformer 3, the primary circuit current (i.e., the current I1) may flow over a path from the input smoothing capacitor Cin2, through the primary winding 31, the resonant coil Lr, the switching device S3, the switching device S4, and the primary low voltage line L1L in this order, and back to the input smoothing capacitor Cin2. On the secondary side of the transformer 3, the secondary circuit current (i.e., the current I2) may flow over the same path as that during the time period for "Stage 1A" described above.

### Time Period for "Stage 2B"

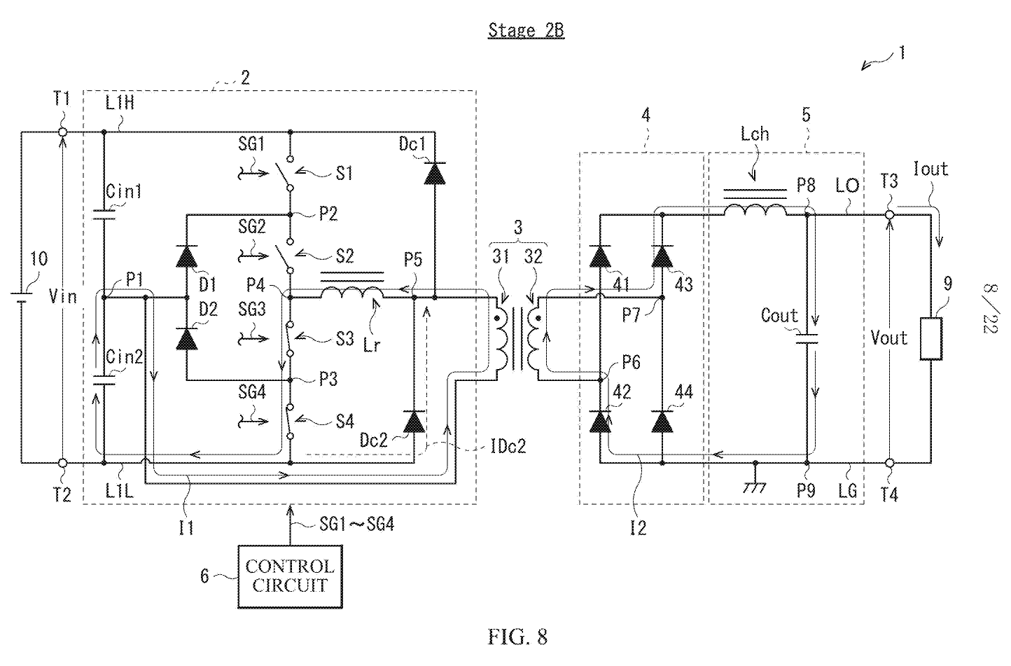

Thereafter, during the time period for "Stage 2B" illustrated in FIG. 8 also, the switching devices S3 and S4 may each be set in the ON state and the switching devices S1 and S2 may each be set in the OFF state (see parts (A) to (D) of FIG. 2), as described above. In this case, on the primary side of the transformer 3, the primary circuit current (i.e., the current I1) may flow over the same path as that during the time period for "Stage 2A" described above, and the current IDc2 may flow through the clamp diode Dc2, as indicated in a dashed arrow in FIG. 8. On the secondary side of the transformer 3, the secondary circuit current (i.e., the current I2) may flow over the same path as that during the time period for "Stage 2A" described above.

### Time Period for "Stage 3B"

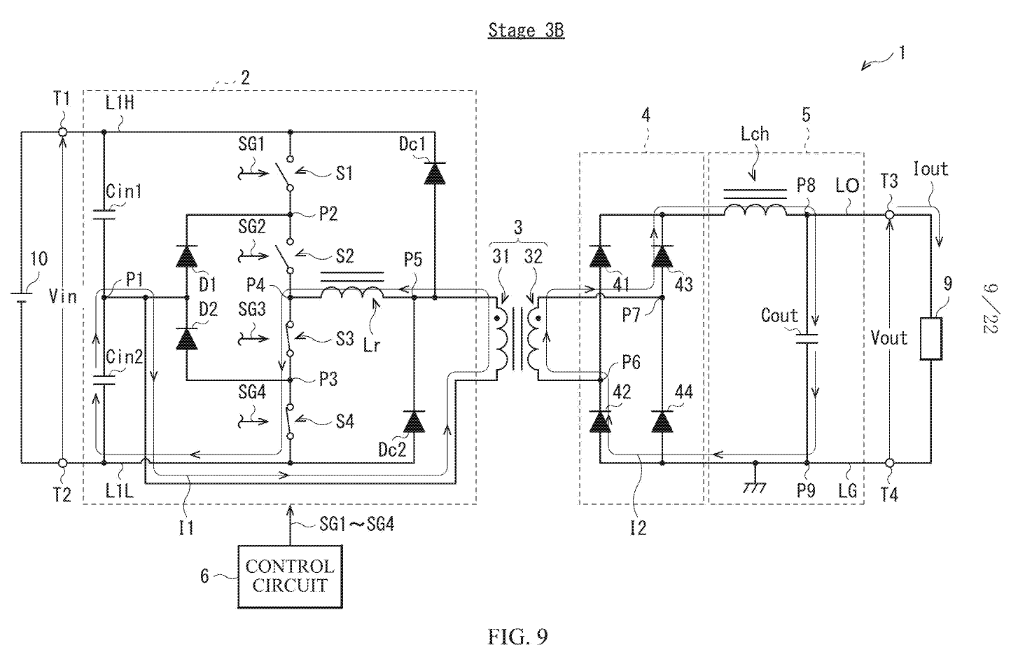

Thereafter, during the time period for "Stage 3B" illustrated in FIG. 9 also, the switching devices S3 and S4 may each be set in the ON state and the switching devices S1 and S2 may each be set in the OFF state (see parts (A) to (D) of FIG. 2), as described above. In this case, on the primary side of the transformer 3, the primary circuit current (i.e., the current I1) may flow over the same path as that during the time period for "Stage 2A" described above, but no current IDc2 may flow through the clamp diode Dc2, unlike during the time period for the "Stage 2B" described above. On the secondary side of the transformer 3, the secondary circuit current (i.e., the current I2) may flow over the same path as that during the time period for "Stage 2A" described above.

### Time Period for "Stage 4B"

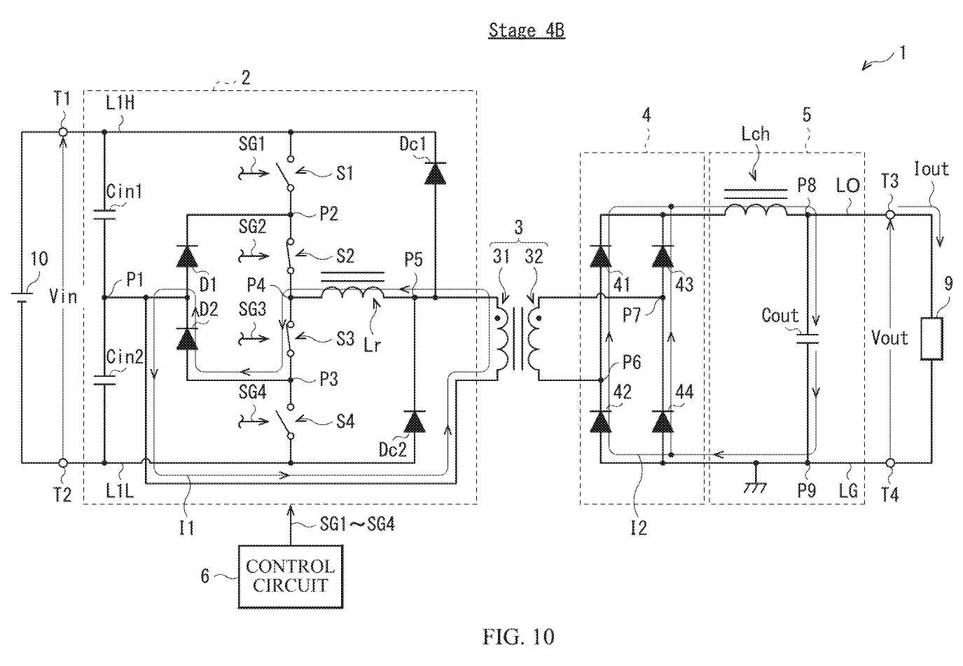

Thereafter, during the time period for "Stage 4B" illustrated in FIG. 10, the switching devices S2 and S3 may each be set in the ON state and the switching devices S1 and S4 may each be set in the OFF state (see parts (A) to (D) of FIG. 2), as described above. In this case, on the primary side of the transformer 3, the primary circuit current (i.e., the current I1) may flow over a path from the resonant coil Lr, through the switching device S3, the diode D2, and the primary winding 31 in this order, and back to the resonant coil Lr. On the secondary side of the transformer 3, the secondary circuit current (i.e., the current I2) may flow over the same path as that during the time period for "Stage 1A" described above.

This is the end of the description of the operation example of the first driving operation illustrated in FIG. 2, i.e., the "PWM control A" described above, during the switching driving in the switching power supply apparatus 1.

### B-2. Example of Second Driving Operation: Phase Shift Control A

FIG. 11 is a timing chart illustrating an operation example of the second driving operation, i.e., the "phase shift control A" described above, during the switching driving in the switching power supply apparatus 1. In FIG. 11, parts (A) to (K) illustrate the same parameters as those in parts (A) to (K) in FIG. 2 described above.

In FIG. 11, as in FIG. 2, the time periods for the eight kinds of operation states, i.e., the respective time periods for "Stage 1A" to "Stage 4B" described above, may proceed in the same order repeatedly to define the switching period Tsw.

As illustrated in FIG. 11, during the time periods for "Stage 1A", "Stage 2A", and "Stage 3A", the switching devices S1 and S2 may each be set in the ON state and the switching devices S3 and S4 may each be set in the OFF state. During the time period for "Stage 4A", the switching devices S2 and S4 may each be set in the ON state and the switching devices S1 and S3 may each be set in the OFF state. During the time periods for "Stage 1B", "Stage 2B", and "Stage 3B", the switching devices S3 and S4 may each be set in the ON state and the switching devices S1 and S2 may each be set in the OFF state. During the time period for "Stage 4B", the switching devices S1 and S3 may each be set in the ON state and the switching devices S2 and S4 may each be set in the OFF state.

In performing the second driving operation, i.e., the "phase shift control A" described above, the control circuit 6 may perform the following switching driving, as illustrated in FIG. 11. When changing the direct-current output voltage Vout, the control circuit 6 may set respective phases ϕ1 and ϕ4 of the driving signals SG1 and SG4 for the switching devices S1 and S4 to be variable. In this case, the control circuit 6 may set respective phases ϕ2 and ϕ3 of the driving signals SG2 and SG3 for the switching devices S2 and S3 to be fixed.

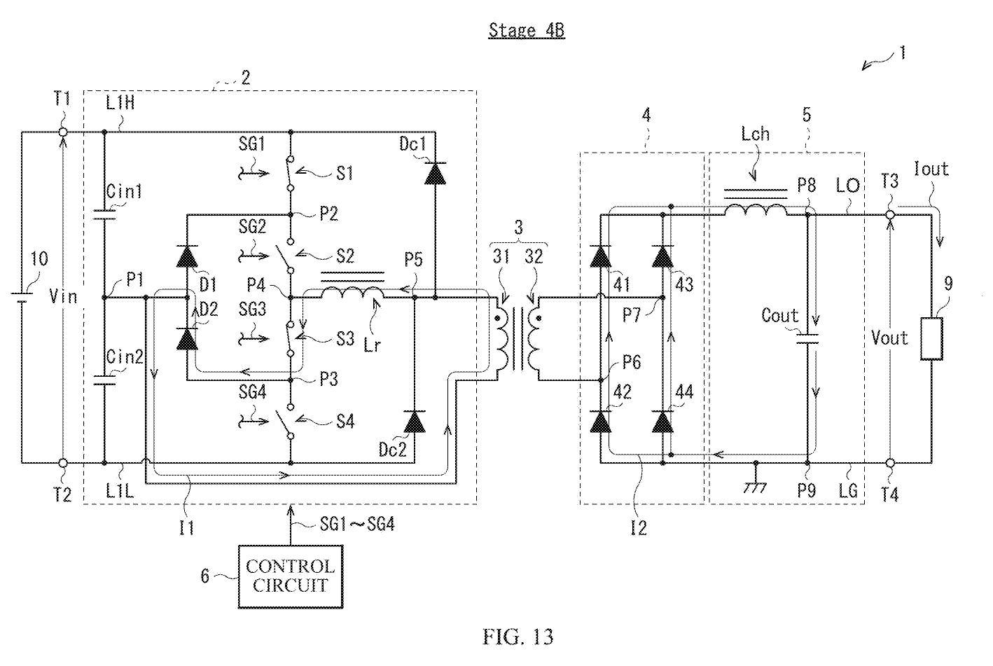

FIGS. 12 and 13 are circuit diagrams illustrating the operation states of the switching power supply apparatus 1 during the respective time periods for "Stage 4A" and "Stage 4B" in FIG. 11. An example operation in each of these operation states will be described in detail below with reference to FIG. 11. The operation states during the other time periods, i.e., the respective time periods for "Stage 1A", "Stage 2A", "Stage 3A", "Stage 1B", "Stage 2B", and "Stage 3B", in the second driving operation are similar to those in the first driving operation described above (see FIGS. 3 to 5 and 7 to 9), and descriptions thereof will thus be omitted.

### Time Period for "Stage 4A"

First, during the time period for "Stage 4A" illustrated in FIG. 12, the switching devices S2 and S4 may each be set in the ON state and the switching devices S1 and S3 may each be set in the OFF state (see parts (A) to (D) of FIG. 11), as described above. In this case, on the primary side of the transformer 3, the primary circuit current (i.e., the current I1) may flow over the path from the resonant coil Lr, through the primary winding 31, the diode D1, and the switching device S2 in this order, and back to the resonant coil Lr. On the secondary side of the transformer 3, the secondary circuit current (i.e., the current I2) may flow over the path from the output smoothing capacitor Cout, through the ground line LG, thereafter through the rectifying diodes 42 and 41 and the rectifying diodes 44 and 43 in parallel, thereafter through the choke coil Lch, and back to the output smoothing capacitor Cout.

### Time Period for "Stage 4B"

Thereafter, during the time period for "Stage 4B" illustrated in FIG. 13, the switching devices S1 and S3 may each be set in the ON state and the switching devices S2 and S4 may each be set in the OFF state (see parts (A) to (D) of FIG. 11), as described above. In this case, on the primary side of the transformer 3, the primary circuit current (i.e., the current I1) may flow over the path from the resonant coil Lr, through the switching device S3, the diode D2, and the primary winding 31 in this order, and back to the resonant coil Lr. On the secondary side of the transformer 3, the secondary circuit current (i.e., the current I2) may flow over the same path as that during the time period for "Stage 4A" described above.

This is the end of the description of the operation example of the second driving operation illustrated in FIG. 11, i.e., the "phase shift control A" described above, during the switching driving in the switching power supply apparatus 1.

### B-3. Example of Third Driving Operation: PWM Control B

FIG. 14 is a timing chart illustrating an operation example of the third driving operation, i.e., the "PWM control B" described above, during the switching driving in the switching power supply apparatus 1. In FIG. 14, parts (A) to (K) illustrate the same parameters as those in parts (A) to (K) in FIG. 2 described above.

In FIG. 14, as in FIG. 2, the time periods for the eight kinds of operation states, i.e., the respective time periods for "Stage 1A" to "Stage 4B" described above, may proceed in the same order repeatedly to define the switching period Tsw.

As illustrated in FIG. 14, during the time periods for "Stage 1A", "Stage 2A", and "Stage 3A", the switching devices S1 and S2 may each be set in the ON state and the switching devices S3 and S4 may each be set in the OFF state. During the time period for "Stage 4A", the switching devices S1 and S4 may each be set in the ON state and the switching devices S2 and S3 may each be set in the OFF state. During the time periods for "Stage 1B", "Stage 2B", and "Stage 3B", the switching devices S3 and S4 may each be set in the ON state and the switching devices S1 and S2 may each be set in the OFF state. During the time period for "Stage 4B", the switching devices S1 and S4 may each be set in the ON state and the switching devices S2 and S3 may each be set in the OFF state.

In performing the third driving operation, i.e., the "PWM control B" described above, the control circuit 6 may perform the following switching driving, as illustrated in FIG. 14. When setting the direct-current output voltage Vout to be relatively high, the control circuit 6 may set the respective pulse widths W1 and W4 of the driving signals SG1 and SG4 for the switching devices S1 and S4 to be relatively small. In this case, the control circuit 6 may set the respective pulse widths W2 and W3 of the driving signals SG2 and SG3 for the switching devices S2 and S3 to be relatively large. In contrast, when setting the direct-current output voltage Vout to be relatively low, the control circuit 6 may set the respective pulse widths W1 and W4 of the driving signals SG1 and SG4 to be relatively large, and set the respective pulse widths W2 and W3 of the driving signals SG2 and SG3 to be relatively small. The third driving operation to be performed in such a manner allows respective values of the currents ID1 and ID2 flowing through the diodes D1 and D2 to be lower than in a case of the first driving operation (the "PWM control A" described above), as seen from parts (H) and (I) of FIG. 2 and parts (H) and (I) of FIG. 14. The third driving operation thus helps to reduce power consumption.

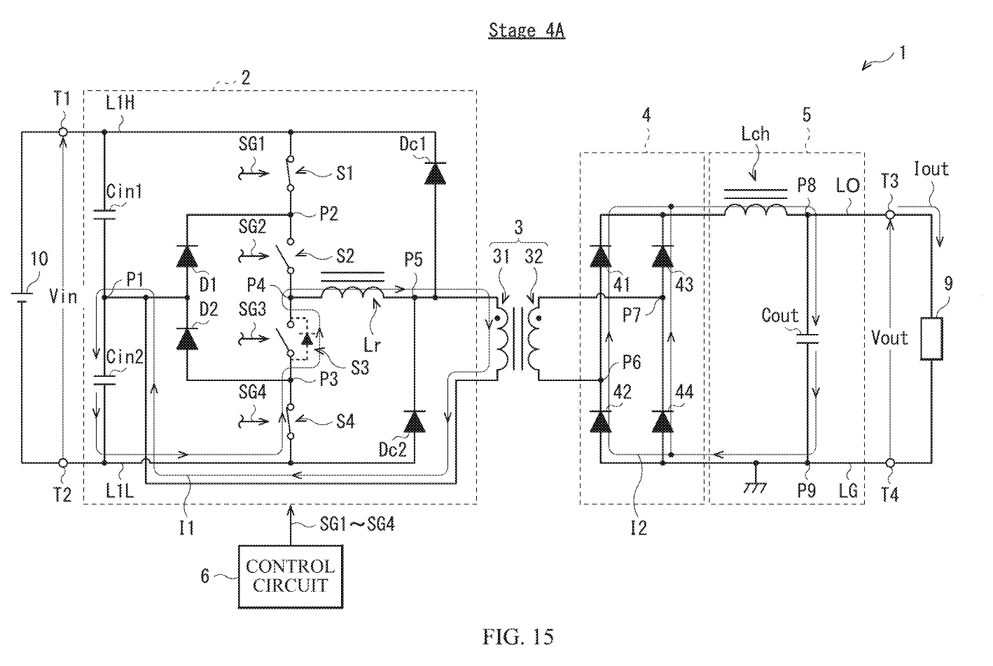

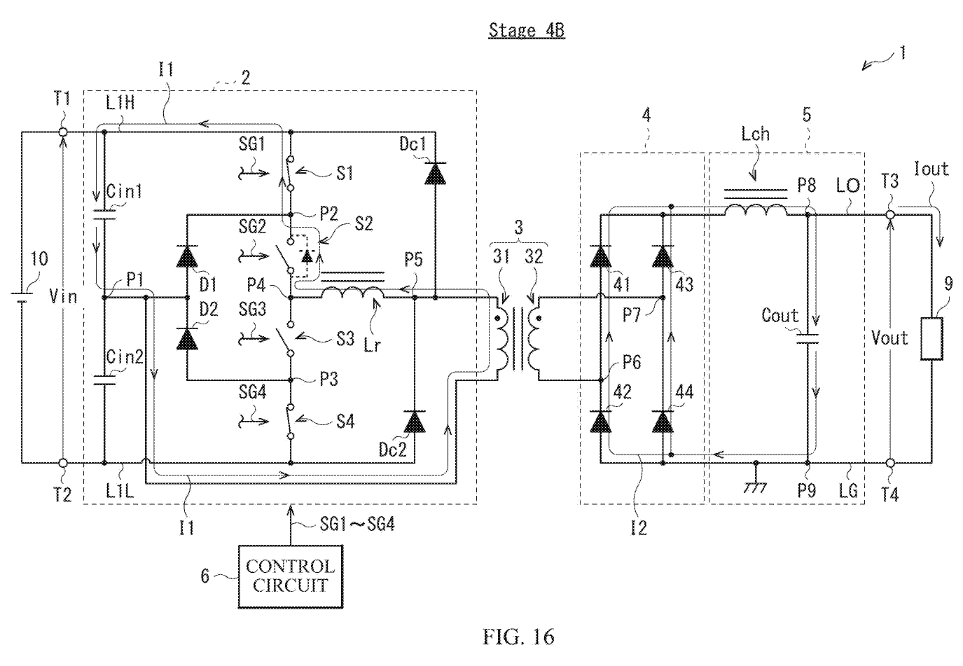

FIGS. 15 and 16 are circuit diagrams illustrating the operation states of the switching power supply apparatus 1 during the respective time periods for "Stage 4A" and "Stage 4B" in FIG. 14. An example operation in each of these operation states will be described in detail below with reference to FIG. 14. The operation states during the other time periods, i.e., the respective time periods for "Stage 1A", "Stage 2A", "Stage 3A", "Stage 1B", "Stage 2B", and "Stage 3B", in the third driving operation are similar to those in the first driving operation described above (see FIGS. 3 to 5 and 7 to 9), and descriptions thereof will thus be omitted.

### Time Period for "Stage 4A"

First, during the time period for "Stage 4A" illustrated in FIG. 15, the switching devices S1 and S4 may each be set in the ON state and the switching devices S2 and S3 may each be set in the OFF state (see parts (A) to (D) of FIG. 14), as described above. In this case, on the primary side of the transformer 3, the primary circuit current (i.e., the current I1) may flow over a path from the resonant coil Lr, through the primary winding 31, the input smoothing capacitor Cin2, the primary low voltage line L1L, the switching device S4, and a parasitic diode of the switching device S3 in this order, and back to the resonant coil Lr. On the secondary side of the transformer 3, the secondary circuit current (i.e., the current I2) may flow over the path from the output smoothing capacitor Cout, through the ground line LG, thereafter through the rectifying diodes 42 and 41 and the rectifying diodes 44 and 43 in parallel, thereafter through the choke coil Lch, and back to the output smoothing capacitor Cout.

### Time Period for "Stage 4B"

Thereafter, during the time period for "Stage 4B" illustrated in FIG. 16 also, the switching devices S1 and S4 may each be set in the ON state and the switching devices S2 and S3 may each be set in the OFF state (see parts (A) to (D) of FIG. 14), as described above. In this case, on the primary side of the transformer 3, the primary circuit current (i.e., the current I1) may flow over a path from the resonant coil Lr, through a parasitic diode of the switching device S2, the switching device S1, the primary high voltage line L1H, the input smoothing capacitor Cin1, and the primary winding 31 in this order, and back to the resonant coil Lr. On the secondary side of the transformer 3, the secondary circuit current (i.e., the current I2) may flow over the same path as that during the time period for "Stage 4A" described above.

This is the end of the description of the operation example of the third driving operation illustrated in FIG. 14, i.e., the "PWM control B" described above, during the switching driving in the switching power supply apparatus 1.

### B-4. Example of Fourth Driving Operation: Phase Shift Control B

FIG. 17 is a timing chart illustrating an operation example of the fourth driving operation, i.e., the "phase shift control B" described above, during the switching driving in the switching power supply apparatus 1. In FIG. 17, parts (A) to (K) illustrate the same parameters as those in parts (A) to (K) in FIG. 2 described above.

In FIG. 17, as in FIG. 2, the time periods for the eight kinds of operation states, i.e., the respective time periods for "Stage 1A" to "Stage 4B" described above, may proceed in the same order repeatedly to define the switching period Tsw.

As illustrated in FIG. 17, during the time periods for "Stage 1A", "Stage 2A", and "Stage 3A", the switching devices S1 and S2 may each be set in the ON state and the switching devices S3 and S4 may each be set in the OFF state. During the time period for "Stage 4A", the switching devices S1 and S3 may each be set in the ON state and the switching devices S2 and S4 may each be set in the OFF state. During the time periods for "Stage 1B", "Stage 2B", and "Stage 3B", the switching devices S3 and S4 may each be set in the ON state and the switching devices S1 and S2 may each be set in the OFF state. During the time period for "Stage 4B", the switching devices S2 and S4 may each be set in the ON state and the switching devices S1 and S3 may each be set in the OFF state.

In performing the fourth driving operation, i.e., the "phase shift control B" described above, the control circuit 6 may perform the following switching driving, as illustrated in FIG. 17. When changing the direct-current output voltage Vout, the control circuit 6 may set the respective phases ϕ1 and ϕ4 of the driving signals SG1 and SG4 for the switching devices S1 and S4 to be fixed. In this case, the control circuit 6 may set the respective phases ϕ2 and ϕ3 of the driving signals SG2 and SG3 for the switching devices S2 and S3 to be variable. The fourth driving operation to be performed in such a manner allows the respective values of the currents ID1 and ID2 flowing through the diodes D1 and D2 to be lower than in a case of the second driving operation (the "phase shift control A" described above), as seen from parts (H) and (I) of FIG. 11 and parts (H) and (I) of FIG. 17. The fourth driving operation thus helps to reduce power consumption.

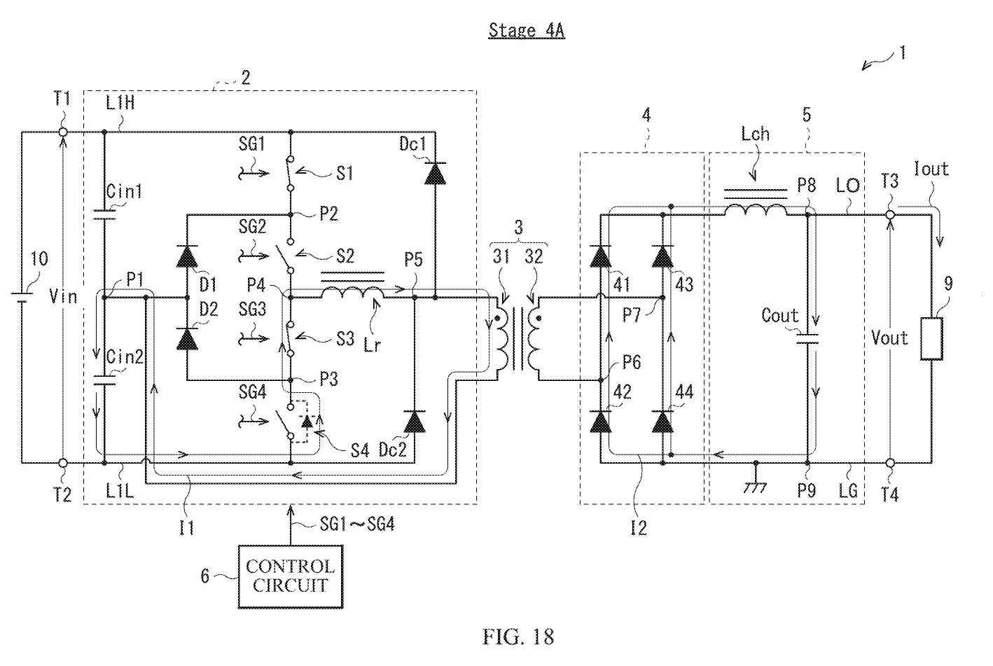

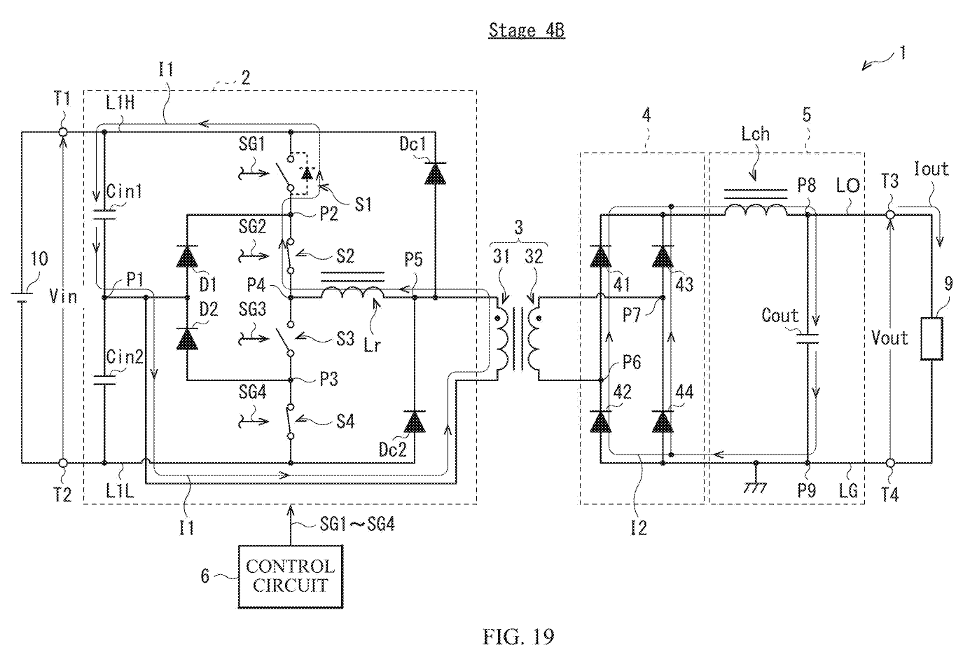

FIGS. 18 and 19 are circuit diagrams illustrating the operation states of the switching power supply apparatus 1 during the respective time periods for "Stage 4A" and "Stage 4B" in FIG. 17. An example operation in each of these operation states will be described in detail below with reference to FIG. 17. The operation states during the other time periods, i.e., the respective time periods for "Stage 1A", "Stage 2A", "Stage 3A", "Stage 1B", "Stage 2B", and "Stage 3B", in the fourth driving operation are similar to those in the first driving operation described above (see FIGS. 3 to 5 and 7 to 9), and descriptions thereof will thus be omitted.

### Time Period for "Stage 4A"

First, during the time period for "Stage 4A" illustrated in FIG. 18, the switching devices S1 and S3 may each be set in the ON state and the switching devices S2 and S4 may each be set in the OFF state (see parts (A) to (D) of FIG. 17), as described above. In this case, on the primary side of the transformer 3, the primary circuit current (i.e., the current I1) may flow over a path from the resonant coil Lr, through the primary winding 31, the input smoothing capacitor Cin2, the primary low voltage line L1L, a parasitic diode of the switching device S4, and the switching device S3 in this order, and back to the resonant coil Lr. On the secondary side of the transformer 3, the secondary circuit current (i.e., the current I2) may flow over the path from the output smoothing capacitor Cout, through the ground line LG, thereafter through the rectifying diodes 42 and 41 and the rectifying diodes 44 and 43 in parallel, thereafter through the choke coil Lch, and back to the output smoothing capacitor Cout.

### Time Period for "Stage 4B"

Thereafter, during the time period for "Stage 4B" illustrated in FIG. 19, the switching devices S2 and S4 may each be set in the ON state and the switching devices S1 and S3 may each be set in the OFF state (see parts (A) to (D) of FIG. 17), as described above. In this case, on the primary side of the transformer 3, the primary circuit current (i.e., the current I1) may flow over a path from the resonant coil Lr, through the switching device S2, a parasitic diode of the switching device S1, the primary high voltage line L1H, the input smoothing capacitor Cin1, and the primary winding 31 in this order, and back to the resonant coil Lr. On the secondary side of the transformer 3, the secondary circuit current (i.e., the current I2) may flow over the same path as that during the time period for "Stage 4A" described above.

This is the end of the description of the operation example of the fourth driving operation illustrated in FIG. 17, i.e., the "phase shift control B" described above, during the switching driving in the switching power supply apparatus 1.

### C. Workings and Example Effects

Workings and example effects of the switching power supply apparatus 1 according to the example embodiment will now be described in detail.

Regarding a switching power supply apparatus (e.g., a DC-to-DC converter) mountable on, for example, a vehicle, demand for a power supply apparatus supporting 800-V input has been increasing in order to meet a requirement for a battery electric vehicle (BEV). Such a power supply apparatus involves a switching device having a high withstand voltage exceeding 1 kV, which leads to a higher cost than that of an existing product. In a case of compromising by using a low-withstand-voltage switching device, a configuration in which switching circuits are coupled in series may be typically employed; however, this leads to an increase in the number of components, and thus would not help to solve an issue of a cost increase.

To address this, a switching power supply apparatus including a switching circuit that allows for a reduction in the number of components has been proposed. However, the use of such a switching circuit can make it difficult to suppress a surge voltage occurring on the secondary side of a transformer. For example, a switching circuit proposed in Japanese Patent No. 6008185 has room for improvement in that enhancing a capability of suppressing a surge voltage can affect an operation of a main circuit.

According to the switching power supply apparatus 1 of the example embodiment, the configuration including the switching circuit 2 described above and the switching driving performed by the control circuit 6 as described above help to achieve a benefit as described below.

During the switching driving (i.e., the first to fourth driving operations) described above, the time periods for "Stage 1A" and "Stage 1B" may each end upon completion of a regeneration operation on the secondary side of the transformer 3, and upon the end of each of the above-described time periods, a reverse voltage is likely to occur at the choke coil Lch. The reverse voltage leads to a surge voltage occurring on the secondary side of the transformer 3 (e.g., at the rectifying circuit 4).

The switching circuit 2 of the example embodiment includes the two clamp diodes Dc1 and Dc2. This helps to suppress the above-described reverse voltage, and to thereby limit the surge voltage occurring at the rectifying circuit 4. Further, the example embodiment helps to suppress an effect on the operation of the main circuit (e.g., the switching circuit 2, the rectifying circuit 4, and the smoothing circuit 5) of the switching power supply apparatus 1, despite the provision of the two clamp diodes Dc1 and Dc2. Thus, the example embodiment helps to suppress the surge voltage occurring on the secondary side of the transformer 3 (e.g., at the rectifying circuit 4) while suppressing an effect on the operation of the main circuit.

### 2. Modification Examples

Modification Examples 1 to 3 of the foregoing example embodiment will now be described. In the following description, the same reference signs are assigned to components the same as those in the example embodiment, and descriptions thereof will be omitted as appropriate.

### Modification Examples 1 and 2

### Configuration

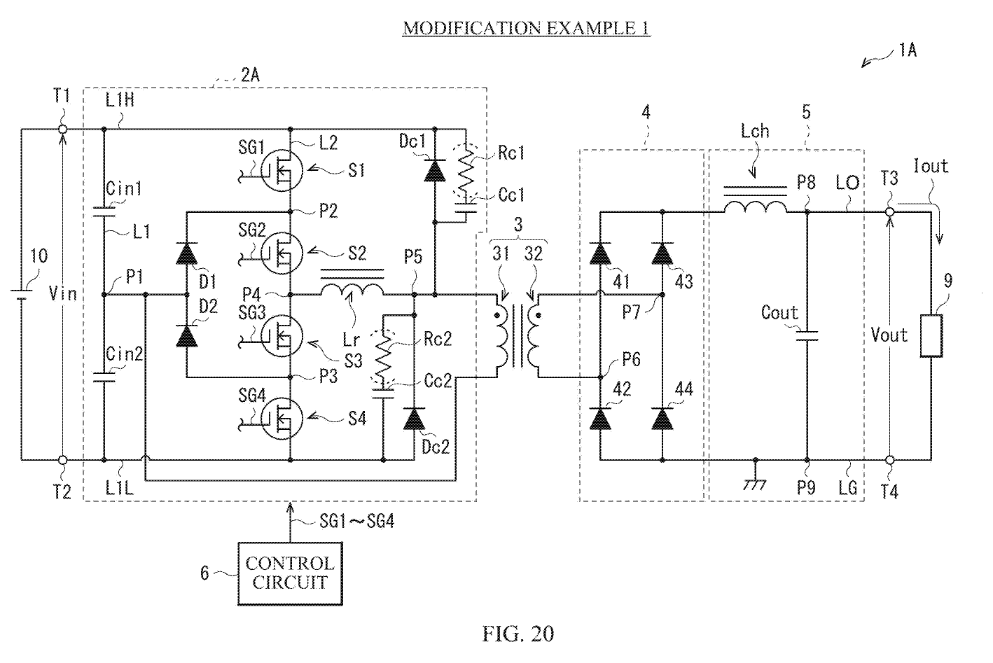

FIG. 20 is a circuit diagram illustrating a schematic configuration example of a switching power supply apparatus 1A according to Modification Example 1. The switching power supply apparatus 1A according to Modification Example 1 may correspond to the switching power supply apparatus 1 according to the example embodiment illustrated in FIG. 1 in which the switching circuit 2 is replaced with a switching circuit 2A, with the remainder of configuration being unchanged.

The switching circuit 2A may have a configuration similar to that of the switching circuit 2, except for further including capacitors Cc1 and Cc2 and resistors Rc1 and Rc2 described below.

For example, in the switching circuit 2A, as illustrated in FIG. 20, a series coupling structure in which the capacitor Cc1 and the resistor Rc1 are coupled in series to each other may be disposed in parallel to the clamp diode Dc1. Similarly, a series coupling structure in which the capacitor Cc2 and the resistor Rc2 are coupled in series to each other may be disposed in parallel to the clamp diode Dc2.

In some embodiments, as indicated by dashed parentheses in FIG. 20, the resistors Rc1 and Rc2 may be omitted from the switching circuit 2A, for example. In other words, in the switching circuit 2A, the capacitor Cc1 alone may be disposed in parallel to the clamp diode Dc1 and the capacitor Cc2 alone may be disposed in parallel to the clamp diode Dc2. In such a case, the capacitors Cc1 and Cc2 may include respective parasitic capacitances of the clamp diodes Dc1 and Dc2, for example.

The capacitor Cc1 may correspond to a specific but non-limiting example of a "first capacitor" in one embodiment of the disclosure, and the capacitor Cc2 may correspond to a specific but non-limiting example of a "second capacitor" in one embodiment of the disclosure. The resistor Rc1 may correspond to a specific but non-limiting example of a "first resistor" in one embodiment of the disclosure, and the resistor Rc2 may correspond to a specific but non-limiting example of a "second resistor" in one embodiment of the disclosure.

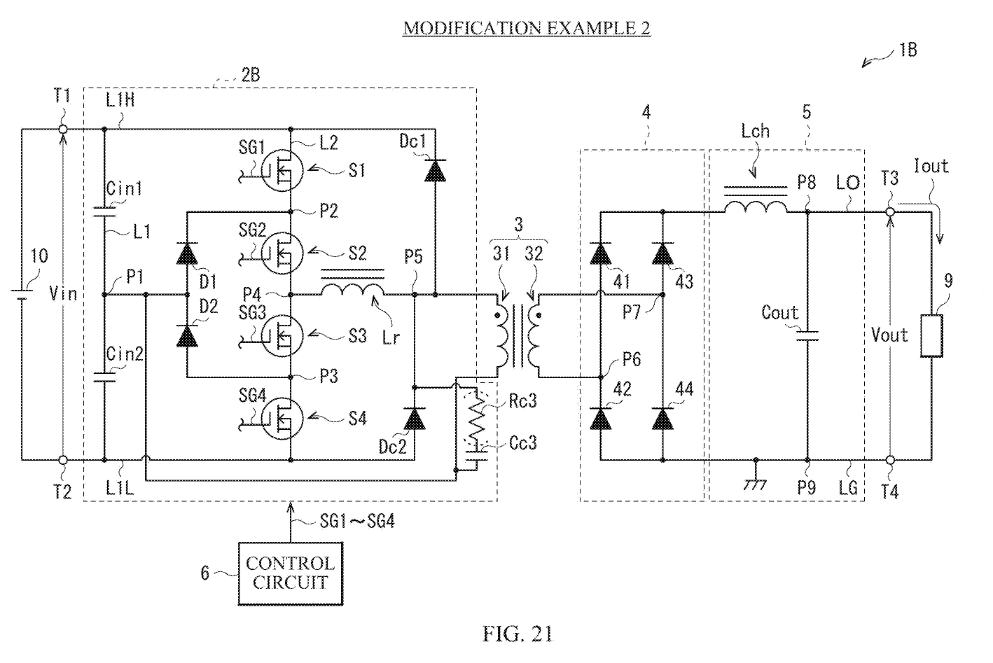

FIG. 21 is a circuit diagram illustrating a schematic configuration example of a switching power supply apparatus 1B according to Modification Example 2. The switching power supply apparatus 1B according to Modification Example 2 may correspond to the switching power supply apparatus 1 according to the example embodiment illustrated in FIG. 1 in which the switching circuit 2 is replaced with a switching circuit 2B, with the remainder of configuration being unchanged.

The switching circuit 2B may have a configuration similar to that of the switching circuit 2, except for further including a capacitor Cc3 and a resistor Rc3 described below.

For example, in the switching circuit 2B, as illustrated in FIG. 21, a series coupling structure in which the capacitor Cc3 and the resistor Rc3 are coupled in series to each other may be disposed in parallel to the primary winding 31. For example, the series coupling structure in which the capacitor Cc3 and the resistor Rc3 are coupled in series to each other may be disposed between the node P5 and the node P1. In some embodiments, as indicated by dashed parentheses in FIG. 21, the resistor Rc3 may be omitted from the switching circuit 2B, for example. In other words, in the switching circuit 2B, the capacitor Cc3 alone may be disposed in parallel to the primary winding 31.

The capacitor Cc3 may correspond to a specific but non-limiting example of a "third capacitor" in one embodiment of the disclosure. The resistor Rc3 may correspond to a specific but non-limiting example of a "third resistor" in one embodiment of the disclosure.

### Workings and Example Effects

Basically, Modification Examples 1 and 2 with such respective configurations each help to achieve effects similar to those achievable with the example embodiment, through similar workings.

Furthermore, Modification Example 1 including the capacitors Cc1 and Cc2 and the resistors Rc1 and Rc2 and Modification Example 2 including the capacitor Cc3 and the resistor Rc3 each help to achieve the following effect.

Typically, a leakage inductance Le will be generated in a transformer unless the transformer is an ideal one. Accordingly, even if the clamp diodes Dc1 and Dc2 are provided, a surge voltage or ringing can occur at any of the rectifying diodes 41 to 44. Modification Example 1 including the capacitors Cc1 and Cc2 and the resistors Rc1 and Rc2 and Modification Example 2 including the capacitor Cc3 and the resistor Rc3 each help to suppress the surge voltage or ringing, as in a case of using an ideal transformer.

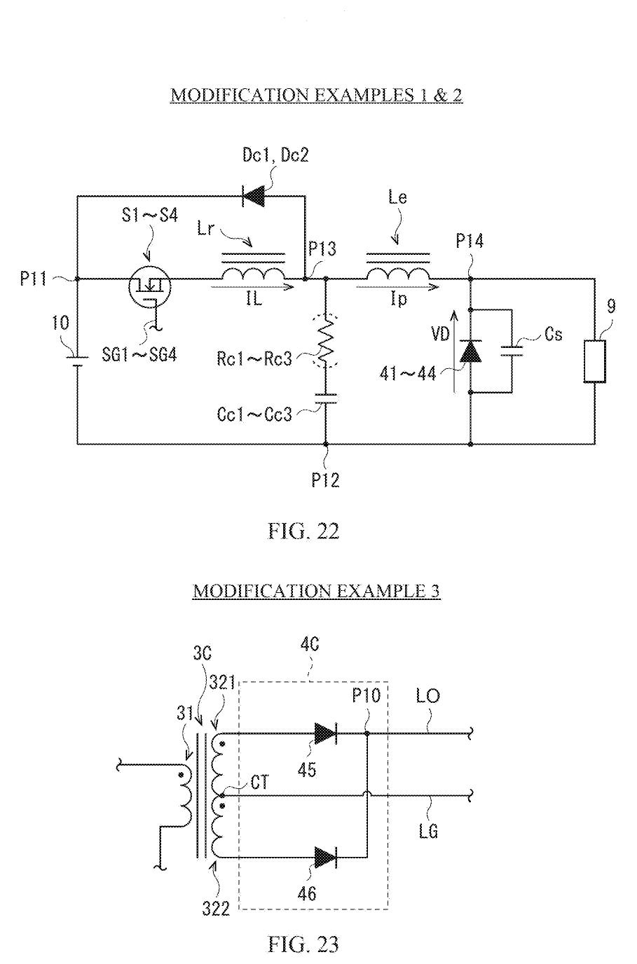

FIG. 22 is a circuit diagram illustrating an example of an equivalent circuit, of Modification Examples 1 and 2, in a state during the time period for each of "Stage 2A" and "Stage 2B" in which the above-described surge voltage or ringing is likely to occur. In the equivalent circuit, the switching devices S1 to S4 and the resonant coil Lr may be disposed in series between a node P11 on a first end side of the direct-current input power supply 10 and a node P13 on a first end side of the leakage inductance Le of the transformer 3. The clamp diodes Dc1 and Dc2 may also be disposed between the nodes P11 and P13. The load 9 may be disposed on a second end side of the leakage inductance Le. Further, a parallel coupling structure in which the rectifying diodes 41 to 44 and their parasitic capacitances Cs are coupled in parallel may also be disposed on the second end side of the leakage inductance Le. A series coupling structure in which the resistors Rc1 to Rc3 and the capacitors Cc1 to Cc3 are coupled in series may be disposed between the node P13 and a node P12 on a second end side of the direct-current input power supply 10. The current Ip described above, a current IL flowing through the resonant coil Lr, and a voltage VD generated at the rectifying diodes 41 to 44 are also illustrated in the equivalent circuit.

In the equivalent circuit illustrated in FIG. 22, the leakage inductance Le and the parasitic capacitances Cs may configure an LC resonant circuit. In the equivalent circuit, the provision of the above-described series coupling structure in which the resistors Rc1 to Rc3 and the capacitors Cc1 to Cc3 are coupled in series helps to allow for damping of the LC resonant circuit, which in turn helps to suppress the surge voltage or ringing described above.

### Modification Example 3

### Configuration

FIG. 23 is a circuit diagram illustrating an example of a transformer 3C and a rectifying circuit 4C according to Modification Example 3.

The transformer 3C may include one primary winding 31 and two secondary windings 321 and 322. Thus, in contrast to the transformer 3 including the single secondary winding 32, the transformer 3C may include the two secondary windings 321 and 322.

The secondary winding 321 may have a first end coupled to an anode of a rectifying diode 45 in the rectifying circuit 4C. The secondary winding 322 may have a first end coupled to an anode of a rectifying diode 46 in the rectifying circuit 4C. The rectifying diodes 45 and 46 will be described later. The secondary windings 321 and 322 may have their respective second ends coupled to each other at a center tap CT. The center tap CT may be coupled to the ground line LG.

The rectifying circuit 4C may include a plurality of rectifying diodes, i.e., the two rectifying diodes 45 and 46 described above. The rectifying circuit 4C may thus include what is called a "center-tap" rectifying circuit.

In the rectifying circuit 4C, as described above, the anode of the rectifying diode 45 may be coupled to the first end of the secondary winding 321, and the anode of the rectifying diode 46 may be coupled to the first end of the secondary winding 322. Respective cathodes of the rectifying diodes 45 and 46 may be coupled to each other at a node P10 on the output line LO.

The rectifying diodes 45 and 46 may correspond to a specific but non-limiting example of the "plurality of rectifiers" in one embodiment of the disclosure.

### Workings and Example Effects

Basically, Modification Example 3 having such a configuration helps to achieve effects similar to those achievable with any of the example embodiment and Modification Examples 1 and 2, through similar workings.

In some embodiments, the rectifying diodes 45 and 46 may include switching devices similar to the switching devices S1 to S4 described above, and may be caused to perform synchronous rectification, that is, caused to be in an ON state in synchronization with time periods during which respective parasitic diodes of those switching devices are conducting. For example, respective switching operations (i.e., ON and OFF operations) of those switching devices may be controlled in accordance with driving signals supplied from the control circuit 6 to thereby cause the switching devices to perform such synchronous rectification.

### 3. Other Modification Examples

The disclosure has been described hereinabove with reference to the example embodiment and the modification examples. However, embodiments of the disclosure are not limited thereto, and various modifications may be made.

For example, in the foregoing example embodiment and modification examples, description has been given of example configurations of the switching circuit; however, such examples are non-limiting, and any other suitable configuration may be employed for the switching circuit. Further, in the foregoing example embodiment and modification examples, description has been given of example configurations of the rectifying circuit; however, such examples are non-limiting, and any other suitable configuration may be employed for the rectifying circuit. Moreover, in the foregoing example embodiment and modification examples, description has been given of example configurations of the smoothing circuit; however, such examples are non-limiting, and any other suitable configuration may be employed for the smoothing circuit.

Further, in the foregoing example embodiment and modification examples, description has been given of example configurations of the transformer including the primary winding and the secondary winding; however, such examples are non-limiting, and any other suitable configuration may be employed for the transformer including the primary winding and the secondary winding.

Further, in the foregoing example embodiment and modification examples, description has been given of example operations during the switching driving (i.e., examples of the foregoing first to fourth driving operations) to be performed by the control circuit; however, such examples are non-limiting, and any other suitable operations may be employed.

Moreover, any two or more of the configuration examples described so far may be combined and applied in a desired manner. The disclosure encompasses any possible combination of some or all of the various embodiments described herein and incorporated herein.

The effects described herein are mere examples, and effects of an embodiment of the disclosure are not limited thereto. Accordingly, any other effect may be obtained in relation to the embodiment of the disclosure.

It is possible to achieve at least the following configurations from the foregoing example embodiment and modification examples of the disclosure.

<1> A switching power supply apparatus including:
a pair of input terminals configured to receive an input voltage, and including a first input terminal and a second input terminal;
a pair of output terminals configured to output an output voltage;
a transformer including a primary winding and a secondary winding;
a switching circuit disposed between the pair of input terminals and the primary winding, and including a first coupling line, a second coupling line, first to fourth switching devices, a first input capacitor, a second input capacitor, a first diode, a second diode, a first clamp diode, a second clamp diode, and a resonant coil, the first coupling line and the second coupling line being disposed in parallel to each other between the first input terminal and the second input terminal;
a rectifying circuit disposed between the pair of output terminals and the secondary winding, and including a plurality of rectifiers;
a smoothing circuit disposed between the pair of output terminals and the rectifying circuit; and
a control circuit configured to perform switching driving to control respective operations of the first to fourth switching devices, in which
in the switching circuit,
   the first input capacitor and the second input capacitor are disposed on the first coupling line in series to each other and in this order in a direction from the first input terminal toward the second input terminal;
   the first to fourth switching devices are disposed on the second coupling line in series to each other and in this order in the direction from the first input terminal toward the second input terminal;
   the first diode is disposed between a first node and a second node, and the second diode is disposed between a third node and the first node, the first node being a node between the first input capacitor and the second input capacitor, the second node being a node between the first switching device and the second switching device, the third node being a node between the third switching device and the fourth switching device;
   the resonant coil and the primary winding are disposed in series to each other between a fourth node and the first node, the fourth node being a node between the second switching device and the third switching device; and
   the first clamp diode is disposed between a fifth node and the first input terminal, and the second clamp diode is disposed between the second input terminal and the fifth node, the fifth node being a node between the resonant coil and the primary winding.

<2> The switching power supply apparatus according to <1>, in which
the rectifying circuit includes a full-bridge rectifying circuit, and
the plurality of rectifiers includes four rectifiers.

<3> The switching power supply apparatus according to <1>, in which
the rectifying circuit includes a center-tap rectifying circuit, and
the plurality of rectifiers includes two rectifiers.

<4> The switching power supply apparatus according to any one of <1> to <3>, further including either:
1) a first capacitor, a second capacitor, a first resistor, and a second resistor; or
2) the first capacitor and the second capacitor, without the first resistor and the second resistor, in which
   either the first capacitor or a series coupling structure in which the first capacitor and the first resistor are coupled in series to each other is disposed in parallel to the first clamp diode, and
   either the second capacitor or a series coupling structure in which the second capacitor and the second resistor are coupled in series to each other is disposed in parallel to the second clamp diode.

<5> The switching power supply apparatus according to <4>, in which
the first capacitor is disposed in parallel to the first clamp diode,
the second capacitor is disposed in parallel to the second clamp diode,
he first capacitor includes a parasitic capacitance of the first clamp diode, and
the second capacitor includes a parasitic capacitance of the second clamp diode.

<6> The switching power supply apparatus according to any one of <1> to <3>, further including either:
1) a third capacitor and a third resistor; or
2) the third capacitor, without the third resistor, in which
   either the third capacitor or a series coupling structure in which the third capacitor and the third resistor are coupled in series to each other is disposed in parallel to the primary winding.

<7> The switching power supply apparatus according to any one of <1> to <6>, in which the control circuit is configured to, during the switching driving,
when setting the output voltage to be relatively high, set a pulse width of a driving signal for each of the first and fourth switching devices to be relatively large and set a pulse width of a driving signal for each of the second and third switching devices to be relatively small, and
when setting the output voltage to be relatively low, set the pulse width of the driving signal for each of the first and fourth switching devices to be relatively small and set the pulse width of the driving signal for each of the second and third switching devices to be relatively large.

<8> The switching power supply apparatus according to any one of <1> to <6>, in which the control circuit is configured to, during the switching driving, when changing the output voltage, set a phase of a driving signal for each of the first and fourth switching devices to be variable and set a phase of a driving signal for each of the second and third switching devices to be fixed.

<9> The switching power supply apparatus according to any one of <1> to <6>, in which
the control circuit is configured to, during the switching driving,
when setting the output voltage to be relatively high, set a pulse width of a driving signal for each of the first and fourth switching devices to be relatively small and set a pulse width of a driving signal for each of the second and third switching devices to be relatively large, and
when setting the output voltage to be relatively low, set the pulse width of the driving signal for each of the first and fourth switching devices to be relatively large and set the pulse width of the driving signal for each of the second and third switching devices to be relatively small.

<10> The switching power supply apparatus according to any one of <1> to <6>, in which the control circuit is configured to, during the switching driving, when changing the output voltage, set a phase of a driving signal for each of the first and fourth switching devices to be fixed and set a phase of a driving signal for each of the second and third switching devices to be variable.

A switching power supply apparatus according to at least one embodiment of the disclosure makes it possible to suppress a surge voltage occurring on the secondary side of a transformer, while suppressing an effect on the operation of a main circuit.

Although the technology has been described hereinabove in terms of the example embodiment and modification examples, the technology is not limited thereto. It should be appreciated that variations may be made in the described example embodiment and modification examples by those skilled in the art without departing from the scope of the disclosure as defined by the following claims. The limitations in the claims are to be interpreted broadly based on the language employed in the claims and not limited to examples described in this specification or during the prosecution of the application, and the examples are to be construed as non-exclusive. The use of the terms first, second, etc. do not denote any order or importance, but rather the terms first, second, etc. are used to distinguish one element from another. The term "substantially" and its variants are defined as being largely but not necessarily wholly what is specified as understood by one of ordinary skill in the art. The term "disposed on/ provided on/ formed on" and its variants as used herein refer to elements disposed directly in contact with each other or indirectly by having intervening structures therebetween. Moreover, no element or component in this disclosure is intended to be dedicated to the public regardless of whether the element or component is explicitly recited in the following claims.

What is claimed is:

1. A switching power supply apparatus comprising:
a pair of input terminals configured to receive an input voltage, and including a first input terminal and a second input terminal;
a pair of output terminals configured to output an output voltage;
a transformer including a primary winding and a secondary winding;
a switching circuit disposed between the pair of input terminals and the primary winding, and including a first coupling line, a second coupling line, first to fourth switching devices, a first input capacitor, a second input capacitor, a first diode, a second diode, a first clamp diode, a second clamp diode, and a resonant coil, the first coupling line and the second coupling line being disposed in parallel to each other between the first input terminal and the second input terminal,
a rectifying circuit disposed between the pair of output terminals and the secondary winding, and including a plurality of rectifiers;
a smoothing circuit disposed between the pair of output terminals and the rectifying circuit; and
a control circuit configured to perform switching driving to control respective operations of the first to fourth switching devices, wherein
in the switching circuit,
the first input capacitor and the second input capacitor are disposed on the first coupling line in series to each other and in this order in a direction from the first input terminal toward the second input terminal;
the first to fourth switching devices are disposed on the second coupling line in series to each other and in this order in the direction from the first input terminal toward the second input terminal;
the first diode is disposed between a first node and a second node, and the second diode is disposed between a third node and the first node, the first node being a node between the first input capacitor and the second input capacitor, the second node being a node between the first switching device and the second switching device, the third node being a node between the third switching device and the fourth switching device;
the resonant coil and the primary winding are disposed in series to each other between a fourth node and the first node, the fourth node being a node between the second switching device and the third switching device; and
the first clamp diode is disposed between a fifth node and the first input terminal, and the second clamp diode is disposed between the second input terminal and the fifth node, the fifth node being a node between the resonant coil and the primary winding.

2. The switching power supply apparatus according to claim 1, wherein
the rectifying circuit comprises a full-bridge rectifying circuit, and
the plurality of rectifiers comprises four rectifiers.

3. The switching power supply apparatus according to claim 1, wherein
the rectifying circuit comprises a center-tap rectifying circuit, and
the plurality of rectifiers comprises two rectifiers.

4. The switching power supply apparatus according to claim 1, further comprising either: 1) a first capacitor, a second capacitor, a first resistor, and a second resistor; or 2) the first capacitor and the second capacitor, without the first resistor and the second resistor, wherein
either the first capacitor or a series coupling structure in which the first capacitor and the first resistor are coupled in series to each other is disposed in parallel to the first clamp diode, and
either the second capacitor or a series coupling structure in which the second capacitor and the second resistor are coupled in series to each other is disposed in parallel to the second clamp diode.

55 The switching power supply apparatus according to claim 2, further comprising either: 1) a first capacitor, a second capacitor, a first resistor, and a second resistor; or 2) the first capacitor and the second capacitor, without the first resistor and the second resistor, wherein
either the first capacitor or a series coupling structure in which the first capacitor and the first resistor are coupled in series to each other is disposed in parallel to the first clamp diode, and
either the second capacitor or a series coupling structure in which the second capacitor and the second resistor are coupled in series to each other is disposed in parallel to the second clamp diode.

6. The switching power supply apparatus according to claim 3, further comprising either: 1) a first capacitor, a second capacitor, a first resistor, and a second resistor; or 2) the first capacitor and the second capacitor, without the first resistor and the second resistor, wherein
either the first capacitor or a series coupling structure in which the first capacitor and the first resistor are coupled in series to each other is disposed in parallel to the first clamp diode, and
either the second capacitor or a series coupling structure in which the second capacitor and the second resistor are coupled in series to each other is disposed in parallel to the second clamp diode.

7. The switching power supply apparatus according to claim 4, wherein
the first capacitor is disposed in parallel to the first clamp diode,
the second capacitor is disposed in parallel to the second clamp diode,
the first capacitor includes a parasitic capacitance of the first clamp diode, and
the second capacitor includes a parasitic capacitance of the second clamp diode.

8. The switching power supply apparatus according to claim 5, wherein
the first capacitor is disposed in parallel to the first clamp diode,
the second capacitor is disposed in parallel to the second clamp diode,
the first capacitor includes a parasitic capacitance of the first clamp diode, and
the second capacitor includes a parasitic capacitance of the second clamp diode.

9. The switching power supply apparatus according to claim 6, wherein
the first capacitor is disposed in parallel to the first clamp diode,
the second capacitor is disposed in parallel to the second clamp diode,
the first capacitor includes a parasitic capacitance of the first clamp diode, and
the second capacitor includes a parasitic capacitance of the second clamp diode.

10. The switching power supply apparatus according to claim 1, further comprising either: 1) a third capacitor and a third resistor; or 2) the third capacitor, without the third resistor, wherein
either the third capacitor or a series coupling structure in which the third capacitor and the third resistor are coupled in series to each other is disposed in parallel to the primary winding.

11. The switching power supply apparatus according to claim 2, further comprising either: 1) a third capacitor and a third resistor; or 2) the third capacitor, without the third resistor, wherein
either the third capacitor or a series coupling structure in which the third capacitor and the third resistor are coupled in series to each other is disposed in parallel to the primary winding.

12. The switching power supply apparatus according to claim 3, further comprising either: 1) a third capacitor a third resistor; or 2) the third capacitor, without the third resistor, wherein
either the third capacitor or a series coupling structure in which the third capacitor and the third resistor are coupled in series to each other is disposed in parallel to the primary winding.

13. The switching power supply apparatus according to claim 1, wherein
the control circuit is configured to, during the switching driving,
when setting the output voltage to be relatively high, set a pulse width of a driving signal for each of the first and fourth switching devices to be relatively large and set a pulse width of a driving signal for each of the second and third switching devices to be relatively small, and
when setting the output voltage to be relatively low, set the pulse width of the driving signal for each of the first and fourth switching devices to be relatively small and set the pulse width of the driving signal for each of the second and third switching devices to be relatively large.

14. The switching power supply apparatus according to claim 1, wherein the control circuit is configured to, during the switching driving, when changing the output voltage, set a phase of a driving signal for each of the first and fourth switching devices to be variable and set a phase of a driving signal for each of the second and third switching devices to be fixed.

15. The switching power supply apparatus according to claim 1, wherein
the control circuit is configured to, during the switching driving,
when setting the output voltage to be relatively high, set a pulse width of a driving signal for each of the first and fourth switching devices to be relatively small and set a pulse width of a driving signal for each of the second and third switching devices to be relatively large, and
when setting the output voltage to be relatively low, set the pulse width of the driving signal for each of the first and fourth switching devices to be relatively large and set the pulse width of the driving signal for each of the second and third switching devices to be relatively small.

16. The switching power supply apparatus according to claim 1, wherein the control circuit is configured to, during the switching driving, when changing the output voltage, set a phase of a driving signal for each of the first and fourth switching devices to be fixed and set a phase of a driving signal for each of the second and third switching devices to be variable.
